(19) United States
(12) Patent Application Publication
(10) Pub. No.: US 2026/0313697 A1
(43) Pub. Date: Oct. 8, 2026

(54) RANDOM ACCESS METHOD AND APPARATUS

(71) Applicant: Oswego Technologies, LLC, Columbus, NJ (US)

(72) Inventor: Ali Esswie, Calgary (CA)

(21) Appl. No.: 19/441,943

(22) Filed: Jan. 7, 2026

Related U.S. Application Data
(60) Provisional application No. 63/762,226, filed on Feb. 24, 2025.
(60) Provisional application No. 63/788,661, filed on Apr. 14, 2025.
(60) Provisional application No. 63/825,810, filed on Jun. 18, 2025.

(51) Int. Cl. H04W 74/0833; H04B 7/06; H04L 41/16

(52) U.S. Cl. CPC H04W 74/0833; H04B 7/06952; H04L 41/16

(57) ABSTRACT

A method performed by a user equipment (UE) may comprise receiving, via radio resource control (RRC) signaling, information used to configure a first random access channel (RACH) occasion (RO) of a first RO group for physical random access channel (PRACH) transmissions associated with a same or different beam and a time offset and transmitting one or more PRACH signals on one or more ROs in accordance with the information used to configure and the time offset. In embodiments, the PRACH transmissions are on the same beam, are on different beams or are on same beams and different beams. Separate PRACH transmissions associated with a plurality of beams may be made during a single RO. The plurality of beams may be associated with a same synchronization signal block (SSB).

### CROSS REFERENCE TO RELATED APPLICATIONS

This application claims priority to U.S. Provisional Application No. 63/762,226 filed on Feb. 24, 2025, U.S. Provisional Application No. 63/788,661 filed on Apr. 14, 2025 and U.S. Provisional Application No. 63/825,810 filed on Jun. 18, 2025, the contents of each of which is incorporated by way of reference herein in its entirety.

### BACKGROUND

U.S. Pat. No. 9,563,854 to Cruz Mota et al. titled “Distributed Model Training” describes a method where a device coordinates the training of a machine learning model across multiple devices within a network. Each device trains the model using its local dataset and shares the updated parameters with other devices in a sequence, facilitating collaborative model training without centralizing data.

WO2023213722 to Hojin Kim et al. titled “Advanced Wireless Communication AI/ML Training Techniques” describes event-triggered and periodic approaches for AI/ML applications within radio access networks (RANs). Kim focuses on facilitating federated learning by distributing a global model located in the RAN or server base station to user equipment (UEs) and collecting local model feedback.

US Patent Publication No. 20210266057 to Asplund et al. titled “Beamforming for Random Access Channel (RACH)” is incorporated by reference herein in its entirety. Asplund focuses on beamforming techniques for RACH procedures and describes methods by which a network node performs beamforming to facilitate the random access process, aiming to improve the efficiency and reliability of initial access in wireless communication systems.

US Patent Publication No. 20230116354 to Abedini et al. titled “Two-step random access channel procedure” introduces a two-step RACH procedure aimed at reducing latency and improving efficiency in random access processes. It outlines configurations for RACH occasions and parameters for transmitting and receiving random access messages.

### SUMMARY

A method performed by a user equipment (UE) may comprise receiving, via radio resource control (RRC) signaling, information used to configure a first random access channel (RACH) occasion (RO) of a first RO group for physical random access channel (PRACH) transmissions associated with a same or different beam and a time offset and transmitting one or more PRACH signals on one or more ROs in accordance with the information used to configure and the time offset. In embodiments, the PRACH transmissions are on the same beam, are on different beams or are on same beams and different beams. Separate PRACH transmissions associated with a plurality of beams may be made during a single RO. The plurality of beams may be associated with a same synchronization signal block (SSB).

A method performed by a UE may comprise receiving a synchronization signal block (SSB) and decoding system information (SI). In response to receiving the SI, transmitting a plurality of PRACH signals associated with different beams on one or more random access channel (RACH) occasions (ROs) separated in time. The method may further comprise receiving beam information and transmitting MSG3 in accordance with the beam information. In embodiments, the system supports no less than 4 PRACH transmissions each associated with a different beam. An RO group size may be 2, wherein the RO group is indicated by DCI.

A base station may comprise a processor; and a transceiver. The transceiver may be configured to transmit a master information block (MIB) indicative of a system information block (SIB), wherein the SIB is dedicated to AI and/or ML training information. The transceiver may be configured to send one or more AI models to individual wireless transmit receive units (WTRUs) via dedicated data channels and configured to send one or more AI models to a group of WTRUs via a group-common channel using shared PRBs. In embodiments, the transceiver may transmit downlink control information (DCI) comprising a model ID, a version ID and a group-common radio network temporary identifier (RNTI) corresponding to the one or more AI models of the group of WTRUs.

### BRIEF DESCRIPTION OF THE DRAWINGS

FIG. 1 illustrates the paging beam grouping procedure of a TN deployment;

FIG. 2 illustrates the definition of a new SIB carrying paging beam group information;

FIG. 3 illustrates the first paging indication sweeping over primary beams;

FIG. 4 illustrates the uplink preamble response to a detected paging indication on a primary beam;

FIG. 5 illustrates the proposed paging beam sweeping only over the beams of beam groups of a received uplink response preamble;

FIG. 6 illustrates the device action timeline of the multi-stage paging detection;

FIG. 7 illustrates a flowchart of the proposed multi-stage paging detection;

FIG. 8 illustrates device group dynamic classification for AI training eligibility;

FIG. 9 illustrates AI model aggregation of device AI sub-models at the RAN node;

FIG. 10 illustrates the RAN node action flow of the proposed solution;

FIG. 11 illustrates a wireless transmit receive unit (WTRU) action flow of the proposed solution;

FIG. 12 illustrates a case of the reduced capability random access;

FIG. 13 illustrates a beam assignment of high priority random access beam groups; and

FIG. 14 illustrates the overall action flow of the RAN node.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

As used in this disclosure, the term “wireless transmit receive unit” or “WTRU” is designed to refer to a wireless device that transmits or receives. The term may specifically refer to a user equipment device such as a phone, tablet or other wireless device employed by a user. A WTRU may include a processor, a transceiver, a transmit/receive element, a speaker/microphone, a keypad, a display/touchpad, non-removable memory, removable memory, a power source, a global positioning system (GPS) chipset, and/or other elements/peripherals, among others.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In contemporary cellular networks, such as 5G and the anticipated 6G systems, paging is an indispensable mechanism for alerting idle-mode devices to incoming data or calls. This process enables devices to conserve power by remaining dormant until notified, periodically awakening to check for paging messages from the network. However, the integration of beamforming technology, while enhancing signal precision and reducing interference, has rendered paging increasingly energy inefficient. Due to the network's lack of precise knowledge about a device's location, paging messages may be transmitted across multiple beams through a process known as beam sweeping. This involves sequentially broadcasting the same paging indication over numerous beams—potentially hundreds in dense urban deployments or thousands in non-terrestrial networks (NTN)—resulting in substantial energy consumption by the radio access network (RAN). Simultaneously, user equipment (UE) expends additional power monitoring these beams for relevant messages, exacerbating the inefficiency.

The energy burden of beam sweeping escalates as network density and the number of beams increase, a trend that is particularly pronounced in advanced and expansive network architectures. Conventional attempts to mitigate this inefficiency, such as extending paging cycles to reduce the frequency of checks, fall short of a comprehensive solution. While these measures may lower energy use to some extent, they introduce significant latency, rendering them unsuitable for time-sensitive applications where rapid response is critical. Moreover, such strategies fail to tackle the underlying cause of energy waste: the redundant transmissions and exhaustive beam activations inherent in current paging methods.

WO2019160463 to Johan Rune et al. is disclosed by reference herein in its entirety. WO2019160463 focuses on paging via individual beams. It does not describe grouping beams or dynamically switching to full paging delivery across all beams of a group when an uplink response is detected.

WO2018045307 to Yushu Zhang et al. is disclosed by reference herein in its entirety. The approach in WO2018045307 centers on providing paging over either one beam or multiple beams according to UE conditions. WO2018045307 fails to disclose, among other things, forming groups of beams with a designated primary beam and fails to employ a hash function to calculate a paging sequence index for device grouping.

The standard paging procedure employed by the Radio Access Network (RAN) node to awaken idle-mode devices exhibits significant energy inefficiency arising from the extensive transmission of control and data information across all active beams. This procedure commences with the RAN node transmitting a paging indication through the Physical Downlink Control Channel (PDCCH), which serves to notify an idle device of an impending paging message and directs it to the specific resource allocation on the Physical Downlink Shared Channel (PDSCH) where the paging record resides. The paging record, containing critical information such as the device's identity and the purpose of the paging event, is subsequently transmitted via the PDSCH. However, due to the idle device's unknown precise location within the cell, the RAN node may employ a beam sweeping technique, sequentially transmitting both the PDCCH paging indication and the PDSCH paging record across all active beams to ensure comprehensive coverage and successful reception by the target device. In deployments featuring a high beam density-potentially numbering in the dozens, hundreds, or even thousands in non-terrestrial network scenarios.

This repetitive transmission of identical control and data information over each beam necessitates the activation of numerous radio frequency chains, amplifiers, and associated hardware components for every paging occasion. Consequently, this exhaustive beam sweeping approach results in the RAN node expending substantial energy, as it may allocate significant network resources to redundantly broadcast the same paging-related information across all beams, regardless of the device's actual position. This inherent inefficiency is particularly pronounced in scenarios with frequent paging events or expansive beam configurations, rendering the standard paging procedure a considerable contributor to the overall energy consumption of the network and highlighting the need for innovative solutions to mitigate such wasteful expenditure of resources.

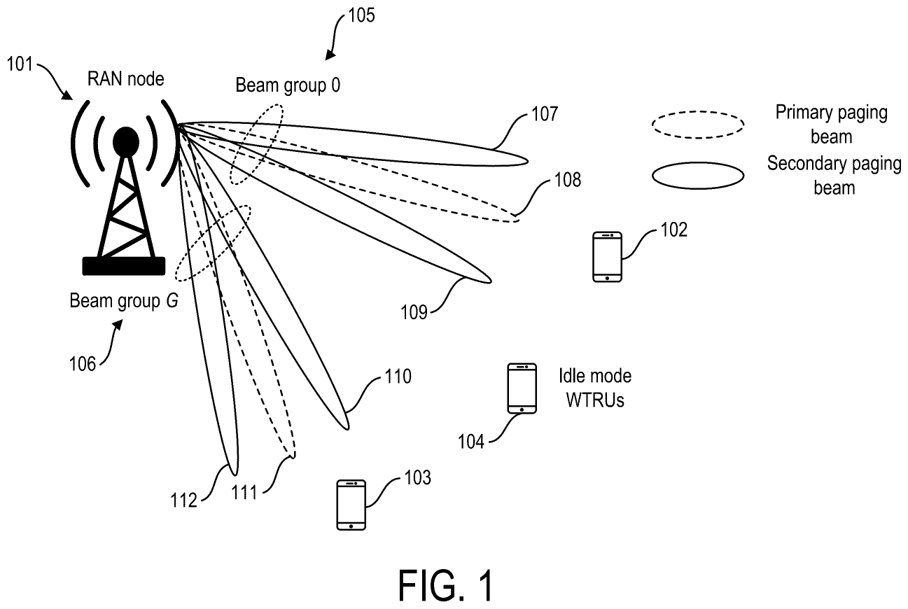

FIG. 1 shows a Radio Access Network (RAN) node 101 implementing a paging indication management process by grouping a plurality of active downlink beams 107-112 into one or more beam groups 105, 106, with each beam group 105, 106 being assigned a primary downlink beam 108, 111 for optimized paging transmission. The active downlink beams 107-112 are initially identified as Synchronization Signal Block (SSB) beams, which are employed by the network to broadcast critical synchronization and system information to devices within its coverage area. These SSB beams are systematically categorized into multiple groups, e.g. 105, 106, typically comprising successive or spatially adjacent beams to ensure cohesive coverage and reduce inter-group interference. Each beam group 105, 106 may then be assigned a primary downlink beam 108, 111, selected based on criteria such as signal strength, coverage overlap, or historical paging traffic associated with the beams in the group. FIG. 1 shows that beam group 0 105 has primary beam 108 and secondary beams 107, 109. Beam group G 106 has primary beam 111 and secondary beams 110, 112. In embodiments, the RAN node may be a base station node, a satellite station node or another type of node.

A designated primary beam may be solely responsible for transmitting paging indications for all devices served by any beam within the same beam group, thereby consolidating the paging transmission duties. Devices associated with the beam group are configured to monitor the assigned primary beam for paging indications, ensuring they remain reachable without the need to activate and monitor multiple beams simultaneously. This approach of grouping beams and assigning a primary beam per group allows the RAN node to minimize the need for exhaustive beam sweeping across all active beams, reducing energy consumption by avoiding redundant transmissions. Consequently, the strategic grouping and primary beam assignment enhance the network's energy efficiency while maintaining reliable coverage and responsiveness for idle-mode devices across the service area.

The method further includes dynamically selecting the primary downlink beam for each paging beam group by the RAN node, wherein the selection is based on a paging load metric derived from historical paging traffic statistics aggregated over a predefined rolling period. The predefined rolling period is configured as a time interval spanning multiple consecutive paging cycles, during which the RAN node tracks, for each beam within a beam group, the cumulative count of paging indications transmitted. The RAN node continuously updates the primary beam designation by prioritizing the beam within the group that has transmitted the largest number of paging indications during the rolling period. This dynamic selection ensures that the primary beam adapts to temporal variations in paging traffic distribution, optimizing resource utilization and alignment with device concentration patterns. Historical statistics, including per-beam paging indication counts, are stored and analyzed to compute the paging load metric, which serves as the basis for primary beam reselection decisions.

Alternatively or in combination, to resolve primary beam prioritization, the RAN node employs a hierarchical selection mechanism. For each beam in the paging beam group, the RAN node maintains a cumulative counter that increments with every paging indication transmitted by the beam during the rolling period. At predefined intervals or upon reaching a threshold number of paging cycles, the RAN node compares the cumulative counts across all beams in the group. The beam with the highest cumulative count is designated as the primary beam. In cases where multiple beams within the group have identical counts, the RAN node applies a tie-breaking criterion that evaluates signal quality metrics, such as reference signal received power (RSRP) or signal-to-interference-plus-noise ratio (SINR), or interference levels measured during recent paging occasions. This ensures that the selected primary beam not only reflects traffic volume but also guarantees reliable coverage by favoring beams with superior radio conditions. The RAN node broadcasts updates to the primary beam designation via the System Information Block (SIB), enabling devices to reconfigure their monitoring to align with the updated primary beam for subsequent paging occasions.

The disclosed beam group paging method is further adaptable to heterogeneous network deployments employing primary and secondary cells (PCell/SCell), where the RAN node coordinates paging across multiple cells to optimize coverage and resource utilization. In such deployments, the primary cell's RAN node assumes responsibility for configuring beam groups spanning both its own beams and those of secondary cells, compiling unified paging beam group information broadcast via the PCell's System Information Block (SIB). Beam groups may aggregate beams from the PCell and SCells based on geographic proximity, overlapping coverage areas, or load-balancing criteria, with primary beam assignments dynamically prioritized across cells to align with device distribution. For instance, a beam group may include a PCell beam and adjacent SCell beams, with the PCell beam initially designated as the primary beam due to its centralized control role.

Devices camped on the PCell determine their best serving beam across both PCell and SCell coverage, measuring RSRP and mapping the selected beam to a cross-cell beam group via the SIB. The hash function parameters (e.g., prime number, group size indication) are harmonized across cells to ensure consistent paging sequence derivation, with the PCell's Cell ID serving as the primary input to avoid ambiguity. During Phase 1 paging, the RAN node transmits paging preambles via the primary beam of each group, which may reside in either the PCell or SCell, depending on historical traffic patterns. Devices monitor their assigned primary beam regardless of its cell origin, overriding SCell-specific decoding configurations if necessary. Upon detecting a preamble match, devices transmit uplink responses via resources mapped to the beam group's originating cell (PCell or SCell), triggering Phase 2 sweeps across all beams in the group, including those in secondary cells.

To manage inter-cell coordination, the PCell's RAN node negotiates beam group topologies and resource allocations with SCells via X2/Xn interfaces, ensuring synchronized SIB updates and collision-free preamble sequencing. Time-domain paging occasions are aligned across cells to prevent overlapping transmissions, while frequency-domain resources are partitioned to avoid inter-cell interference.

The disclosed beam group paging procedure is further extendable to satellite-based Non-Terrestrial Networks (NTNs). A satellite RAN node, configured by a ground gateway, may dynamically group its coverage beams into paging beam groups tailored to geographic regions or mobility footprints. In such deployments, the satellite RAN node executes the two-phase paging mechanism: initially transmitting paging preambles via primary beams of each group, followed by full beam sweeps upon receiving uplink responses from devices. However, due to extended propagation delays inherent in satellite-terrestrial links (e.g., Low Earth Orbit latency ~5-50 ms, Geostationary ~250 ms), the RAN node and devices implement expanded timeout counters for paging phases. For instance, the interval between Phase 1 (primary beam paging) and Phase 2 (full beam sweep) is extended to accommodate round-trip signal propagation, ensuring that uplink preamble responses from devices are not misinterpreted as missed due to latency. Similarly, the device-side timeout for monitoring full paging records is scaled proportionally to the satellite's orbital altitude and beam coverage dynamics, preventing premature termination of paging detection cycles.

The ground gateway configures beam groups based on satellite ephemeris data and predicted beam footprints, adjusting primary beam assignments to account for satellite mobility relative to terrestrial device distributions. Beam group sizes may be enlarged to cover broader geographic regions, with hash function parameters (e.g., prime number, group size indication) optimized for higher device densities per beam. Uplink preamble resources are allocated with extended guard intervals to mitigate Doppler shift effects caused by satellite motion. Crucially, the RAN node synchronizes paging occasions with satellite orbital positioning updates, ensuring beam group validity across dynamic coverage areas. By adapting timeout thresholds and beam group configurations to NTN-specific constraints, the method retains its energy efficiency and latency advantages while ensuring reliable paging delivery in high-latency, mobile satellite environments. This scalability to NTN deployments underscores the method's universality across terrestrial and non-terrestrial cellular ecosystems.

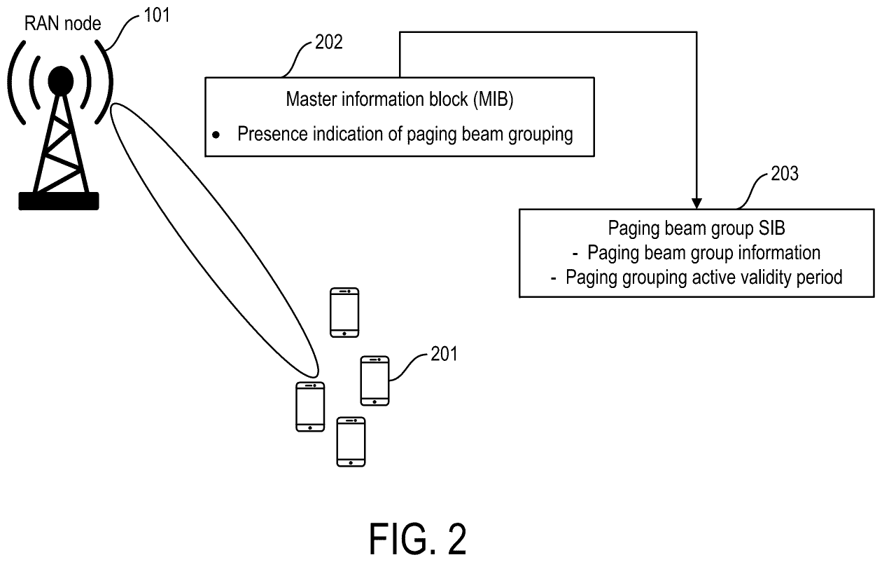

FIG. 2 depicts a RAN node 101 broadcasting paging beam group information and paging detection hash function parameters to idle mode devices 201 via a System Information Block (SIB), which may be integrated into an existing SIB structure or defined as a new SIB type dedicated to paging configurations. To ensure backward compatibility and efficient device resource utilization, the Master Information Block (MIB) 202 transmitted by the RAN node includes a presence indication field that explicitly signals the availability of paging beam group and hash function parameters in the SIB 203. When the presence indication is set to “true” in the MIB, devices may be mandated to search for and decode the corresponding SIB 203 to acquire the paging beam group information and hash parameters. This mechanism allows the RAN node 101 to dynamically enable or disable advanced paging features while ensuring that legacy devices not supporting the new functionality ignore the configuration, thereby avoiding unnecessary processing overhead.

The paging beam group information broadcast in the SIB 203 comprises a group index mapped to constituent beams, primary beam designations, and paging resource occasions defined by time-domain parameters (e.g., system frame number offsets, slot offsets), frequency-domain parameters (e.g., subcarrier spacing, PRB allocations), and periodicity. The paging detection hash function parameters include a set of sequence preambles, hash static constants, a prime number for collision mitigation, and a paging group size indication. These parameters are encapsulated within the SIB as structured fields, enabling devices to compute their assigned paging sequence index using the hash function and align their monitoring to the primary beam of their associated beam group. The RAN node updates the SIB content dynamically in response to network reconfigurations, such as beam group topology changes or adjustments to the hash function configurations.

In one exemplary embodiment, a Radio Access Network (RAN) node manages paging indications by grouping a plurality of active downlink beams into one or more beam groups, with each group assigned a primary downlink beam. The RAN node compiles and broadcasts paging beam group information via a System Information Block (SIB), detailing the beam groups and their associated resource information, such as time and frequency allocations for paging occasions. Furthermore, the RAN node broadcasts paging detection hash function parameters that include device paging grouping configurations, enabling devices to compute their respective paging sequences in a way that is aligned and consistent with the calculations performed at the paging RAN node. For a specific device requiring paging, the RAN node generates a paging sequence index using a hash function that incorporates the RAN node's cell ID, the device's ID, and a configured prime number (i.e., shared among the RAN node and devices). Paging indications, including preambles corresponding to those generated sequences, are then transmitted exclusively via the primary beam of each beam group. When the RAN node receives one or more uplink paging preambles from devices responding to these indications, it activates full paging delivery by compiling and transmitting detailed paging records across all beams only within the beam groups associated with the received uplink preambles, ensuring comprehensive coverage for the paged devices.

The primary downlink beam for each beam group is dynamically selected based on paging traffic. Specifically, the RAN node identifies the beam within each group that has transmitted the highest number of paging indications over a predefined rolling period, typically spanning multiple paging cycles. This selection is continuously updated using a paging load metric derived from historical traffic statistics per beam, ensuring the primary beam reflects current network demands. The RAN node tracks a cumulative count of paging indications for each beam during this period, compares these counts across the group, and designates the beam with the highest count as the primary beam. In cases of equal counts, the RAN node resolves ties by prioritizing beams with better signal quality metrics or lower interference levels. Upon reselection, the RAN node periodically broadcasts updated primary beam indications via the SIB, prompting devices within the beam group to adjust their monitoring to the newly designated primary beam for subsequent paging occasions, thereby optimizing energy efficiency and paging reliability. This way, the RAN node ensures that the majority of the idle mode devices per each paging beam group are monitoring a primary beam that already matches their best serving beam for paging reception.

In another embodiment, the RAN node configures and broadcasts detailed paging beam group information via the SIB to facilitate efficient paging management. This information includes a group index mapped to multiple beams within each beam group, with each beam identified by a unique beam identifier, and a primary beam indication explicitly signaled as a distinct field. The paging beam group information also specifies resource occasion details, such as time-domain parameters (e.g., system frame number (SFN) offset and slot offset), frequency-domain parameters (e.g., subcarrier spacing and physical resource block (PRB) allocation), and periodicity parameters that define the repetition intervals of paging occasions tied to the primary beam. This structured broadcast enables devices to accurately locate and monitor their designated paging opportunities within the network's beamformed structure.

Concurrently, the RAN node compiles and broadcasts paging detection hash function parameters to support device-specific paging sequence generation. These parameters include a set of paging sequence preambles (e.g., S1, S2, . . . , Sn), each uniquely identified by a sequence index and linked to a distinct paging beam group. The parameters also encompass hash function static constants—either predefined or dynamically generated by the RAN node—used alongside the cell ID, device ID, and a prime number to compute a hash output. The prime number is strategically chosen to reduce collision probabilities among paging sequence indices assigned to different devices. Additionally, the parameters specify the number of available paging sequences (N) and a paging group size indication (I), which caps the number of devices per each paging group. The value of N is calculated as the product of the paging group size indication and the total number of beam groups, ensuring proportional allocation of sequences based on active device counts per group. The RAN node updates these hash function parameters periodically via the SIB in response to network changes, such as beam group reconfiguration or cell ID modifications, maintaining the uniqueness and reliability of the paging sequence assignments.

In a further embodiment, the RAN node determines and generates a paging sequence index for a device to be paged using the selected hash function. The process begins by combining the RAN node's cell ID, the device's ID, and a configured prime number. First, a modulo operation is applied to the device ID using a predefined divisor (I) to produce a reduced device ID value that represents a paging device group. This reduced value is then combined with the cell ID by multiplying the cell ID by a scaling factor and adding the reduced device ID, yielding an intermediate value. The intermediate value is multiplied by the prime number to create a hashed output, which is subsequently subjected to a modulo operation using a divisor (N)—the total number of available paging sequences—to finalize the paging sequence index. The RAN node dynamically adjusts N based on network factors like beam group topology or paging traffic load, ensuring the system scales appropriately with demand.

For transmission, the RAN node sends paging indications via the primary beam of each beam group, embedding a paging preamble that corresponds to the generated paging sequence index. This preamble is transmitted during designated paging occasions and encoded with a precoding matrix tailored to the primary beam, optimizing its detectability. The RAN node restricts preamble transmissions to primary beams only, conserving resources by avoiding non-primary beam usage unless full paging delivery is triggered. When uplink paging preambles are received from devices, the RAN node activates full paging delivery, compiling paging records for the associated devices and sweeping these records across all beams within the relevant beam groups. This sweeping ensures that devices with diverse beam preferences or mobility states receive the paging records, enhancing the system's robustness and coverage.

In a further embodiment, the RAN node activates full paging delivery upon receiving uplink paging preambles from devices responding to initial paging indications. The RAN node identifies the beam group tied to each received uplink preamble using a predefined mapping between the uplink preamble sequence, uplink resource for carrying such preamble and the paging beam group attached to it. It then allocates time-frequency resources for transmitting paging records across all beams within the identified groups, ensuring these resources are orthogonalized to prevent interference between overlapping beam groups. During transmission, the RAN node applies beam-specific precoding matrices to each beam, optimized for beamforming gain and spatial coverage, thereby maximizing the likelihood of successful delivery to the intended devices.

The full paging delivery process continues until a predefined timeout period elapses from the start of the transmission or until the RAN node receives acknowledgments from devices that have successfully decoded the paging records. Upon termination, the RAN node reverts to its energy-efficient mode, transmitting paging indications solely via the primary beam of each beam group. This approach balances the need for comprehensive paging coverage during active delivery with resource conservation during idle periods, making it particularly effective in scenarios with variable device activity levels.

In this embodiment, a wireless device receives paging beam group information and paging detection hash function parameters from the RAN node via the SIB. The device determines its best serving beam by measuring the reference signal received power (RSRP) across beams in its coverage area and matches this beam to a beam group listed in the received information. Using the hash function parameters—including the prime number and static constants—the device calculates its paging sequence index based on the cell ID and its own device ID, following the formula broadcast by the RAN node. If the primary beam of the identified beam group differs from the best serving beam, the device temporarily overrides its decoding matrix with one specific to the primary beam, adopting the primary beam's precoding weights or beamforming configurations for the duration of the paging occasion monitoring.

The device monitors the paging occasion tied to the primary beam, identified via time, frequency, and periodicity parameters from the SIB, and decodes the transmitted paging preamble using the primary beam's decoding matrix. If the decoded preamble matches the device's calculated paging sequence index, the device responds by transmitting an uplink paging preamble linked to the current beam group. This uplink preamble is encoded with a sequence tied to the beam group identifier or the detected downlink preamble and transmitted using uplink resources-such as a physical random-access channel (PRACH) or a dedicated paging uplink control channel (PUCCH)-predefined in the SIB or derived from the paging sequence index. After transmission, the device switches to full paging detection mode, monitoring its best serving beam for paging records until successful decoding or a timeout occurs, optimizing both responsiveness and energy use.

In an advanced embodiment, a wireless device enhances paging detection reliability by incorporating a correlation verification step. While monitoring the primary beam's paging occasion, the device decodes the paging preamble and measures the correlation between the decoded preamble and its calculated paging sequence index. To account for potential signal degradation from monitoring a non-best serving beam, the device verifies that this correlation exceeds a predefined threshold before proceeding. Only if the threshold is met does the device transmit an uplink paging preamble, reducing false positives and conserving energy by avoiding unnecessary responses in ambiguous scenarios.

On the RAN node's side, an additional verification process occurs upon receiving uplink preambles. The RAN node checks the correlation between the received preamble and the intended paging group, confirming the association before activating full paging delivery. To adapt to varying network conditions, the RAN node dynamically adjusts these correlation thresholds—for example, raising them by a predefined offset in high-interference environments to minimize errors or lowering them in clear conditions to ensure inclusivity. This dual-layered correlation approach, combined with adaptive thresholding, enhances the paging system's accuracy and efficiency, making it well-suited for dense or challenging network deployments.

Specifically, as shown by TABLE 1, the paging beam group information broadcast by the RAN node via the System Information Block (SIB) comprises a structured dataset that defines the configuration of each beam group and its associated paging resources. Specifically, the information includes a group index uniquely mapped to a plurality of downlink beams aggregated into the beam group, where each constituent beam is identified by a beam identifier (ID) or a primary beam indication explicitly signaled as a distinct field within the SIB. The primary beam indication designates, for each beam group, the beam currently selected as the primary transmission point for paging indications.

Additionally, the SIB may further encapsulate paging resource occasion information that specifies time-domain parameters, including a system frame number (SFN) offset and slot offset, to define the precise timing of paging occasions relative to a reference frame. Frequency-domain parameters are further detailed, such as subcarrier spacing and physical resource block (PRB) allocations, to establish the spectral resources reserved for paging transmissions. Periodicity parameters are included to define repetition intervals for the paging occasions associated with the primary beam, ensuring deterministic scheduling aligned with device monitoring cycles. Collectively, these parameters enable devices to identify their assigned beam group, locate the primary beam's paging occasions in time and frequency, and synchronize their monitoring activities to minimize missed paging events while conserving power during inactive intervals. The explicit signaling of beam identifiers and primary beam designations within the SIB ensures unambiguous device-side interpretation, even in dynamically reconfigured networks where beam topologies or primary beam assignments may evolve over time.

TABLE 1
paging beam group information
Paging beam group information

| Beam group 0 | Beam indications 0, 1, 2 | Primary beam index 1 |
|---|---|---|
| Beam group G | Beam indications 1025, | Primary beam index 1026 |
| | 1026, 1027 | |

Furthermore, as illustrated by TABLE 2, the RAN node compiles and broadcasts paging detection hash function parameters to enable devices to derive their assigned paging sequence indices, comprising a set of predefined paging sequence preambles (S₁, S₂, . . . , Sₙ), each uniquely identified by a sequence index and mapped to a distinct paging beam group. These parameters further include one or more hash function static constants, which are predefined or dynamically generated by the RAN node to facilitate device-side computation of a hash output using a combination of the RAN node's Cell ID, the Device ID of the target user equipment (UE) [to be paged], and a prime number configured to minimize collision probabilities between paging sequence indices assigned to different devices. The prime number is selected based on the total number of active devices and the desired collision resistance, ensuring that the hash function distributes paging sequences uniformly across the available preamble set.

Additionally, the RAN node broadcasts the number of available paging sequences (N) and a paging group size indication (I), which defines the maximum number of devices associated with each paging sequence preamble. The value of I is derived from network load conditions and device density, enabling the RAN to balance paging group sizes and limit contention during preamble detection. Together, these parameters allow devices to compute their unique paging sequence index by applying the hash function to their Device ID and Cell ID, modulo the divisor N, thereby aligning their monitoring activities with the specific preamble assigned to their paging group. The dynamic configurability of the prime number and hash constants ensures adaptability to evolving network conditions, such as changes in device population or beam group topology, while maintaining deterministic and collision-resistant paging sequence allocation.

TABLE 2
paging hash function information
Paging hash function

Set of paging sequence preambles (S1, S2, . . . , Sn),
each associated with a certain paging beam group index
One or more hash function static constants (a, b)
and a hash function prime number
Number of available paging sequences (N),
and paging group size indication (I)

The number of available paging sequences N is dynamically determined by the RAN node as the product of the paging group size indication I, which defines the maximum number of devices assigned to a single paging sequence preamble, and the total number of beam groups configured in the network. This multiplicative relationship ensures that each beam group is allocated a distinct subset of paging sequences proportional to its active device count, enabling scalable and load-balanced paging resource distribution across beam groups. For instance, if a beam group serves a higher density of devices, the RAN node increases its allocated paging sequence subset by adjusting I or the total beam group count, thereby preventing resource contention while maintaining collision probabilities within acceptable thresholds.

The RAN node continuously recalculates N in response to network reconfigurations, such as beam group additions, removals, or changes in device density, ensuring that the total sequence pool adapts to current traffic patterns. Devices compute their paging sequence index by applying the hash function to their Device ID and Cell ID, followed by a modulo operation with N, which inherently maps them to a sequence within their beam group's allocated subset. This proportional allocation mechanism optimizes paging capacity utilization, minimizes collisions between devices in overlapping beam groups, and ensures equitable resource partitioning in heterogeneous network topologies. The RAN node broadcasts the updated NN value via the System Information Block (SIB), enabling devices to dynamically recalibrate their hash computations and maintain alignment with the evolving paging sequence distribution.

The method for determining and generating the paging sequence index involves a multi-step hash function executed by the RAN node to uniquely map each device to a paging sequence. Based on the following formula, the RAN node computes the index by first applying a modulo operation to the Device ID of the target device using a predefined divisor I, which corresponds to the paging group size indication, to generate a reduced Device ID value. This reduction partitions devices into logical paging groups of size I, ensuring that devices within the same group share a common paging sequence. The reduced Device ID is then combined with the Cell ID of the RAN node by multiplying the Cell ID by a scaling factor and adding the reduced Device ID value, producing a combined intermediate value. The scaling factor is configured to shift the Cell ID's numeric representation, preventing overlap between devices in different cells.

The intermediate value is subsequently multiplied by a prime number, preconfigured or dynamically selected by the RAN node, to generate a hashed output. The prime number introduces non-linearity into the hash function, minimizing the probability of collisions between devices with adjacent or similar Device IDs. Finally, a modulo operation is applied to the hashed output using a divisor N, where N equals the total number of available paging sequences broadcast in the System Information Block (SIB), to compute the final paging sequence index. This index directly maps to one of the preambles (S1, S2, . . . , SN) reserved for paging indications, ensuring that devices monitor the correct preamble during primary beam paging occasions. The RAN node dynamically adjusts the prime number, scaling factor, and divisor N to adapt to network topology changes or device density fluctuations, maintaining collision resistance and efficient paging resource allocation. The hash function's deterministic nature guarantees that devices independently derive the same paging sequence index as the RAN node, enabling synchronized paging detection without explicit per-device signaling.

$$Index = hash ( CellID , ( Device ID mod I ) ) ∖ mod N$$

The divisor N, used in the final modulo operation of the hash function to compute the paging sequence index, is configured to equal the number of paging sequence preambles explicitly broadcast in the System Information Block (SIB). This ensures a direct, one-to-one mapping between the derived paging sequence index and the available preamble pool, guaranteeing that devices and the RAN node remain synchronized in their interpretation of paging indications. The RAN node dynamically updates the value of N in response to changes in network configurations, such as modifications to beam group topology (e.g., merging or splitting beam groups), adjustments to the paging group size indication I, or fluctuations in paging traffic load. For instance, if the network scales to accommodate additional beam groups or increased device density, the RAN recalculates N to expand the preamble pool, thereby reducing collision probabilities and maintaining alignment between paging resources and device distribution. Conversely, during periods of reduced traffic, N may be decreased to conserve resources.

These updates are propagated to devices via the SIB, requiring devices to recompute their paging sequence indices using the revised N. The dynamic adaptation of N ensures that the hash function remains optimized for current network conditions, balancing paging capacity with collision resistance. By tying N directly to the preamble count in the SIB, the system guarantees that devices always reference a valid preamble subset, even as the network evolves. This flexibility enables seamless scalability in heterogeneous deployments, where beam group configurations and device populations vary spatially or temporally, while preserving deterministic paging detection across all operational states.

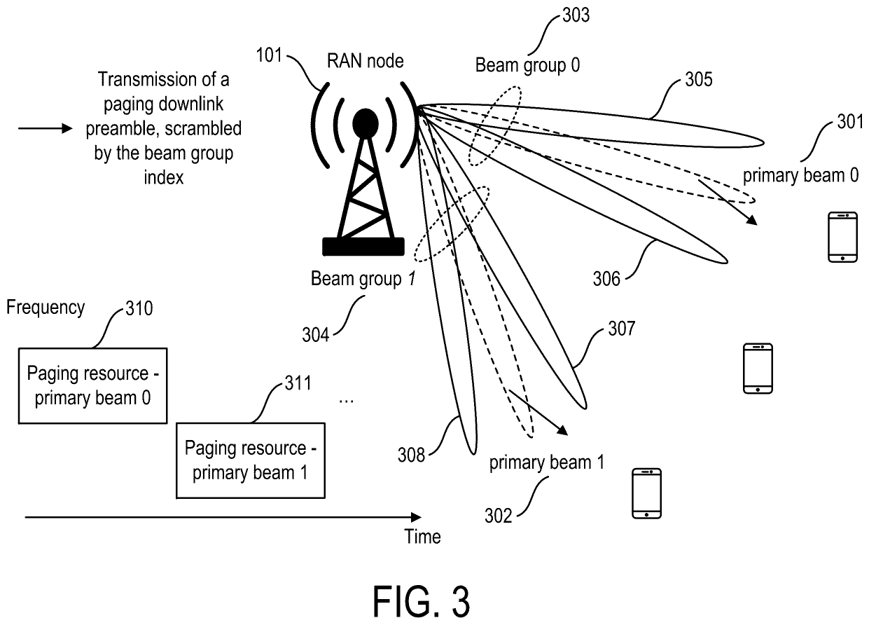

FIG. 3 shows a RAN node 101 transmitting paging indications by encoding and broadcasting a paging preamble corresponding to the generated paging sequence index exclusively via the primary beam 301, 302 of each beam group 303, 304 during predefined paging occasions. The paging preamble is encoded using a beam-specific precoding matrix optimized for the radiation pattern and spatial characteristics of the primary beam, ensuring maximal beamforming gain and coverage within the beam group's service area. These paging occasions are scheduled according to time-domain parameters (e.g., SFN offset, slot offset) and frequency-domain parameters (e.g., subcarrier spacing, PRB allocation) broadcast in the System Information Block (SIB), enabling devices to synchronize their monitoring activities.

The RAN node 101 restricts the transmission of paging preambles from non-primary beams 305-308 unless a full paging record delivery is triggered, thereby conserving network resources and minimizing interference. Full paging delivery may be activated only upon receipt of one or more uplink paging preambles from devices, at which point the RAN node compiles and transmits paging records across all beams within the associated beam groups. This two-phase approach ensures initial paging efficiency via primary beams while guaranteeing comprehensive coverage during subsequent transmissions. The precoding matrix applied to the primary beam is dynamically adjusted based on real-time channel state information (CSI) or historical beam performance metrics, ensuring adaptive alignment with prevailing radio conditions. By limiting non-primary beam paging transmissions to reactive scenarios, the method reduces unnecessary beam sweeping overhead and prioritizes resource allocation for active paging sessions, striking a balance between energy efficiency and reliable paging delivery in dynamic beamformed environments.

In embodiments, the RAN node 101 may transmit on alternative frequency resources over time. For instance, at a first time/frequency instance 310, primary beam 0 may be used. At a second time/frequency resource 311, primary beam 1 may be used. The first time/frequency resource 310 may be different in both time and frequency from the second time/frequency resource 311.

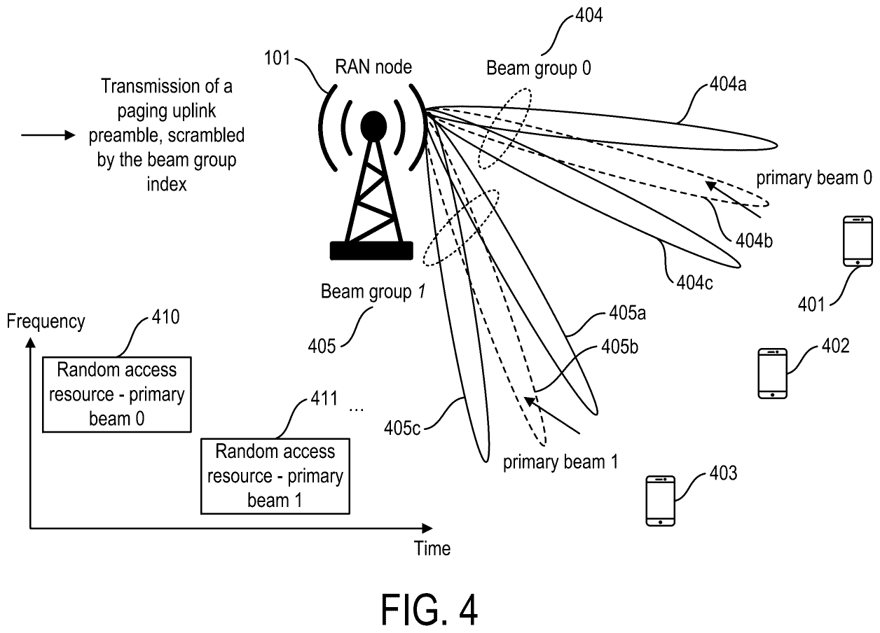

FIG. 4 illustrates the RAN node 101 initiating a critical phase of paging delivery upon detecting uplink paging response preambles transmitted by devices during uplink resource occasions associated with one or more primary beams. These uplink resource occasions are predefined in the System Information Block (SIB), specifying time-frequency resources, e.g. random access resource-primary beam 0 410 and random access resource-primary beam 1 411, allocated for devices to transmit acknowledgment preambles upon detecting a paging indication on the primary beam, intended for themselves and/or for their own paging groups. When the RAN node receives one or more uplink preambles, it identifies the originating beam group(s) by mapping the received preamble sequences to their corresponding beam group indices, as predefined in the paging configuration. This detection serves as explicit confirmation that at least one device within the identified beam group(s) requires paging record delivery, thereby triggering a full paging sweep exclusively over the beams belonging to those beam groups.

Specifically, FIG. 4 shows a RAN node 101 that employs beam groups, including beam group 0 404 and beam group 1 405. Beam group 0 404 comprises beams 404a, 404b and 404c of which beam 404b is the primary beam. Beam group 405 comprises beams 405a, 405b and 405c, of which beam 405b is the primary beam. Wireless device 401 may utilize beam group 0 404. Wireless device 402 may not utilize beam group 0 404 or beam group 1 405. Wireless device 403 may utilize beam group 1 405.

The RAN node 101 compiles paging records for all devices associated with the detected preamble(s) and transmits the records across all downlink beams within the relevant beam groups, employing beam-sweeping to ensure coverage for devices that may have shifted from their initial best-serving beam due to mobility or channel variations. This selective activation of full paging delivery ensures resource efficiency by limiting beam sweeps to groups with active devices, avoiding unnecessary transmissions in groups with no responsive devices. The RAN node 101 dynamically allocates orthogonalized resources during the sweep to mitigate inter-beam interference and applies beam-specific precoding matrices to optimize transmission quality. By linking full paging activation directly to uplink preamble detection, the method ensures deterministic, load-aware resource utilization while maintaining reliable coverage for devices with heterogeneous beam alignments or transient connectivity states. The RAN terminates the full paging sweep after a predefined timeout or upon receiving device acknowledgments, reverting to primary beam-only paging until subsequent uplink triggers are detected.

Specifically, upon receiving one or more uplink paging preambles from devices, the RAN node activates a full paging delivery phase by compiling paging records for all devices associated with the detected preambles. The RAN node identifies the paging beam group linked to each received uplink preamble through a predefined mapping between preamble sequences, and/or uplink resource occasions and beam group indices. Subsequently, the RAN transmits the compiled paging records over all downlink beams within the identified beam groups, executing a beam-sweeping procedure to ensure spatial coverage for devices with diverse beam preferences, alignment mismatches, or mobility states.

During this phase, the RAN node allocates orthogonalized time-frequency resources across the beams of the associated beam groups to avoid interference between overlapping transmissions. Beam-specific precoding matrices, optimized for each beam's radiation pattern and channel conditions, are applied to enhance signal quality and reliability. This sweeping mechanism guarantees that devices receive paging records regardless of their current beam alignment, particularly addressing scenarios where devices have moved from their original best-serving beam or are experiencing transient signal degradation.

The RAN node terminates the full paging delivery phase after a predefined timeout period or upon receiving acknowledgments from devices confirming successful paging record decoding, reverting thereafter to primary beam-only paging indications. By dynamically expanding paging coverage in response to uplink triggers, the method balances resource efficiency with robustness, ensuring reliable delivery in dynamic environments while minimizing unnecessary beam activation.

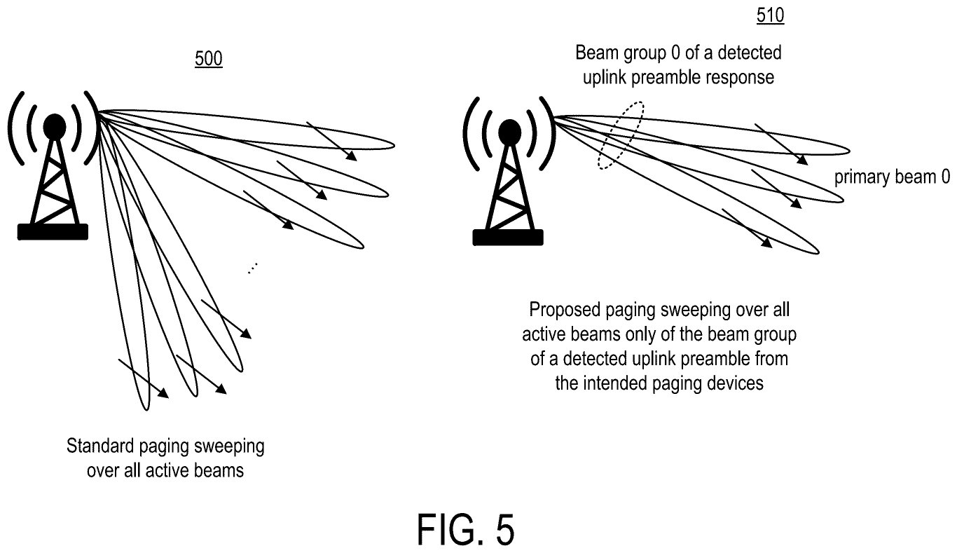

FIG. 5 depicts a comparison between conventional 500 and proposed paging sweeping 510 where conventional paging 500 methods in beamformed networks mandate sweeping paging indications across all active downlink beams-a process that becomes prohibitively inefficient in dense deployments where thousands of beams may exist. Such blanket sweeping consumes excessive energy, as the RAN node transmits paging records redundantly across beams irrelevant to the target devices' locations, while also introducing significant detection delays as devices may monitor all beams indiscriminately.

In contrast, the method 500 introduces a hierarchical, beam group-centric paging mechanism that drastically reduces resource waste. By dynamically grouping beams into logical paging beam groups and initially transmitting paging indications only via the primary beam of each group, the RAN node confines the first-phase paging to a minimal subset of beams statistically likely to cover the target devices. This primary beam transmission is coupled with a hash-based addressing scheme, where devices compute a preamble-specific paging sequence index tied to their beam group, enabling deterministic monitoring of a single primary beam. Crucially, full paging sweeps across all beams within a beam group are activated only if the RAN node receives uplink preambles from devices in that group, confirming the presence of target devices. This two-phase approach ensures that energy-intensive beam sweeping is restricted to beam groups with active devices, avoiding wasteful transmissions in groups with no responsive users.

The proposed method achieves significant reductions in paging detection latency, particularly in networks deploying massive beam counts, by replacing conventional full-beam sweeps with a hierarchical two-phase paging mechanism. In a conventional system, a RAN node with 1,024 active beams, for example, would require 1,024 time units (e.g., slots) to sweep paging indications across all beams, forcing devices to monitor all beams indiscriminately and incurring prohibitive delays. Under the disclosed method, the RAN node organizes the 1,024 beams into logical paging beam groups (e.g., 4 groups of 256 beams each). During the first paging phase, the RAN transmits paging preambles solely via the primary beam of each group—consuming only 4 time units (one per group)—enabling devices to monitor a single primary beam rather than all beams. Devices compute their paging sequence index via a hash function tied to their beam group, ensuring targeted monitoring. If devices in two beam groups respond with uplink preambles (consuming 2 additional time units), the RAN activates the second paging phase, sweeping paging records across all beams within those two groups (256 beams/group×2 groups=512 beams). Combined with the initial 4-slot preamble phase and 2-slot uplink response window, the total latency amounts to 4+2+512=518 time units—a 50% reduction compared to the conventional 1,024-unit sweep.

This latency reduction stems from the method's ability to confine full beam sweeps to active groups with responsive devices, avoiding redundant transmissions in idle groups. The hash-based addressing further minimizes collisions, ensuring devices rapidly detect paging via primary beams. Moreover, the primary beam's high reliability (enabled by optimized precoding and resource allocation) reduces false negatives, while the fallback mechanism guarantees robustness. By dynamically adjusting beam group sizes and hash parameters via SIB updates, the RAN node adapts to varying device densities, sustaining latency gains even as networks scale. The hierarchical approach thus transforms paging from a rigid, resource-intensive broadcast into an adaptive, load-aware process, achieving proportional latency savings in ultra-dense deployments while maintaining deterministic coverage.

Furthermore, on the wireless device side, it first determines its best serving beam by measuring reference signal received power (RSRP) across all downlink beams within its coverage area, selecting the beam with the highest RSRP as the optimal candidate for initial paging detection. Upon identifying the best serving beam, the device cross-references the received paging beam group information broadcast in the System Information Block (SIB) to map the best serving beam to its corresponding beam group. This mapping is achieved by matching the beam identifier of the best serving beam to the beam group's constituent beam list explicitly defined in the SIB, thereby associating the device with the logical beam group and its designated primary beam.

The device then calculates its unique paging sequence index by applying the hash function formula broadcast by the RAN node, which combines the Cell ID of the serving cell, the device's own Device ID, and the configured prime number. The calculation involves modular arithmetic operations and static hash constants provided in the SIB, ensuring deterministic derivation of the paging sequence index that aligns with the RAN node's computations. By leveraging the prime number and hash constants, the device minimizes the likelihood of sequence collisions while generating an index that maps to a preamble within the subset allocated to its beam group.

This process enables the device to monitor the primary beam of its assigned beam group during predefined paging occasions, synchronizing its reception with the RAN node's paging transmissions. The RSRP-based beam selection, coupled with hash-driven sequence indexing, ensures that the device operates efficiently within the hierarchical paging framework, reducing blind beam searches and power consumption while maintaining alignment with network-configured beam group topologies and dynamic hash parameters.

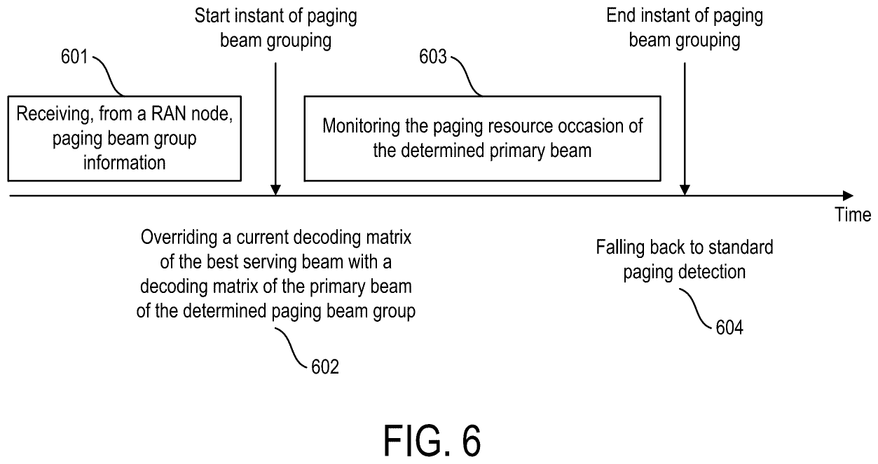

FIG. 6 illustrates the wireless device verifying whether the primary beam of its identified beam group, as specified in the received paging beam group information 601, differs from its locally determined best serving beam. If a discrepancy exists, the device temporarily overrides 602 its default decoding matrix—configured for the best serving beam—by adopting a decoding matrix specifically associated with the primary beam's precoding weights or beamforming configurations. This override is applied exclusively during the paging occasion intervals defined for the primary beam, ensuring compatibility with the RAN node's paging preamble transmissions.

The device retrieves the primary beam's decoding parameters from the System Information Block (SIB), which includes precoding matrix indicators (PMIs), beamforming vectors, or spatial filtering coefficients tailored to the primary beam's radiation pattern. By reconfiguring 603 its receiver chain to align with the primary beam's characteristics, the device mitigates potential misalignment between its best serving beam (optimized for general data reception) and the primary beam (optimized for paging traffic), thereby enhancing paging preamble detection reliability. After the paging occasion concludes, the device reverts 604 to its default decoding matrix for the best serving beam, minimizing disruption to ongoing data sessions. This dynamic reconfiguration ensures that devices prioritize paging detection accuracy during critical intervals while maintaining optimal beam alignment for other services.

The override mechanism is executed autonomously by the device based on SIB parameters, requiring no explicit signaling from the RAN node, thereby conserving uplink resources and reducing latency. Additionally, the device validates the primary beam's signal quality during the override period using embedded reference signals (e.g., CSI-RS) to ensure sustained decodeability, reverting to alternative strategies if signal degradation exceeds a predefined threshold. This adaptive approach balances paging reliability with operational continuity in dynamic beamformed environments.

The wireless device further detects a matching paging preamble by measuring a correlation threshold between the decoded preamble signal, received during the primary beam's paging occasion, and the locally calculated paging sequence derived from the hash function. The device computes the correlation metric using time-domain cross-correlation or frequency-domain matched filtering techniques, quantifying the similarity between the received preamble waveform and the expected sequence. To account for potential signal degradation caused by monitoring a non-best serving beam (e.g., due to beam misalignment or interference), the device verifies that the correlation value exceeds a predefined margin above a detection threshold. This margin is dynamically adjusted based on historical signal quality metrics or explicitly configured by the RAN node via the System Information Block (SIB) to compensate for anticipated degradation in non-optimal beam scenarios.

On condition of the correlation threshold satisfied, the device triggers the transmission of an uplink paging preamble, confirming its presence to the RAN node and initiating full paging delivery. The predefined margin ensures robustness against false positives caused by noise or partial preamble detection, particularly when the device monitors the primary beam instead of its best serving beam. Prior to preamble transmission, the device validates the uplink timing advance and power control parameters associated with the primary beam's paging group to ensure synchronization with the RAN node. This correlation-based verification mechanism guarantees reliable paging detection even under suboptimal beam conditions, while minimizing spurious uplink transmissions that could congest the network. The RAN node may periodically update the correlation margin via SIB to adapt to evolving channel conditions or beam topology changes, ensuring sustained detection accuracy across diverse operational environments.

The wireless device accordingly transmits the uplink paging preamble via either a physical random-access channel (PRACH) resource or a dedicated paging uplink control channel (PUCCH) resource, as specified in the System Information Block (SIB). The mapping between the uplink preamble and the allocated resource is predefined in the SIB or dynamically configured by the RAN node based on the paging beam group index associated with the device's detected downlink paging sequence. For PRACH-based transmission, the SIB defines PRACH occasions, preamble formats, and frequency offsets specific to each beam group, enabling devices to select resources orthogonal to those of other groups to minimize contention.

For PUCCH-based transmission, the RAN node allocates dedicated time-frequency resources and cyclic shifts linked to the paging sequence index or beam group identifier, ensuring interference-free uplink signaling. Dynamic resource configuration adapts to network load or beam group reconfigurations, with the RAN node updating resource mappings via SIB to reflect changes in beam group topology or paging traffic distribution. Devices derive the exact resource location by combining the beam group index with predefined offsets or hashing parameters broadcast in the SIB, ensuring deterministic access aligned with the RAN node's expectations. This dual-mode flexibility allows the system to leverage PRACH for contention-based initial access scenarios or PUCCH for low-latency, grant-free paging responses, depending on network configuration. The beam group-indexed resource mapping ensures spatial separation of uplink transmissions, reducing intra-cell interference and improving detection reliability at the RAN node. By binding resource allocation to beam group indices, the method optimizes uplink resource utilization while maintaining backward compatibility with legacy PRACH/PUCCH frameworks, enabling seamless integration into existing cellular networks.

Following the transmission of the uplink paging preamble, the wireless device activates a full paging detection mode by reconfiguring its receiver to monitor paging records on its best serving beam instead of the primary beam of the assigned beam group. This transition is triggered autonomously by the device upon successful uplink preamble transmission, anticipating that the RAN node may initiate full paging delivery across all beams within the relevant beam group. The device reverts to the best serving beam—previously identified via RSRP measurements—to leverage its optimal signal quality and beamforming alignment, thereby maximizing the likelihood of successfully decoding the paging record. During this phase, the device applies the decoding matrix, precoding weights, and beamforming configurations specific to the best serving beam, overriding the temporary primary beam parameters used during the initial paging occasion monitoring.

The full paging detection mode persists until the device either successfully decodes the paging record addressed to its Device ID or a predefined timeout period expires, whichever occurs first. The timeout duration is configured by the RAN node via the System Information Block (SIB) or derived from historical paging latency statistics, ensuring that the device does not indefinitely prolong monitoring in cases of failed delivery. By reactivating the best serving beam, the device aligns its reception with the RAN node's beam-swept paging record transmissions, which span all beams in the beam group to accommodate mobility or beam misalignment. This dual-phase monitoring strategy—primary beam for initial detection and best serving beam for record reception—strikes a balance between energy efficiency and reliability, as the device avoids redundant beam scans while capitalizing on the superior link quality of its optimal beam. Upon timeout or successful decoding, the device resumes default operation, periodically monitoring the primary beam for future paging indications unless reconfigured by updated SIB parameters. This method ensures minimal latency and power consumption during critical paging sessions while maintaining adaptability to dynamic network conditions.

In scenarios where a wireless device fails to successfully decode a paging preamble transmitted via the primary beam of its assigned beam group—despite detecting energy or partial preamble signatures—the device may autonomously trigger a proactive uplink paging response preamble transmission to the RAN node. This fallback mechanism safeguards against false negatives caused by transient signal degradation, beam misalignment, or interference during the primary beam's paging occasion. Upon detecting an undecodable preamble that correlates weakly with its calculated sequence index (e.g., below the predefined margin but above a noise threshold), the device assumes a paging indication may still be intended for itself and transmits an uplink preamble using resources mapped to its beam group. The RAN node, upon receiving this unsolicited uplink preamble, initiates a full paging record sweep across all beams within the device's beam group, irrespective of whether a valid downlink preamble was originally transmitted. This ensures that devices experiencing momentary primary beam link failure receive paging records during the subsequent beam-swept phase.

To mitigate unnecessary resource consumption, the device employs probabilistic backoff or contention resolution parameters (e.g., randomized delay intervals) before retransmitting uplink preambles, reducing collision risks in cases of simultaneous false triggers. The RAN node may further refine this behavior by broadcasting adaptive thresholds (e.g., minimum correlation levels for proactive triggers) via SIB updates, ensuring the fallback mechanism remains a rare occurrence. By design, the primary beam's paging preamble is configured with robust modulation and coding schemes (e.g., low spectral efficiency, high repetition) to achieve ultra-high detection reliability, minimizing reliance on the fallback. However, the mechanism provides critical redundancy for edge cases, such as devices in high-mobility states or at cell boundaries, where beam dynamics or interference may transiently compromise primary beam reception. This dual-layer approach-optimized primary beam reliability coupled with reactive fallback-ensures near-deterministic paging delivery while maintaining the system's energy efficiency advantages.

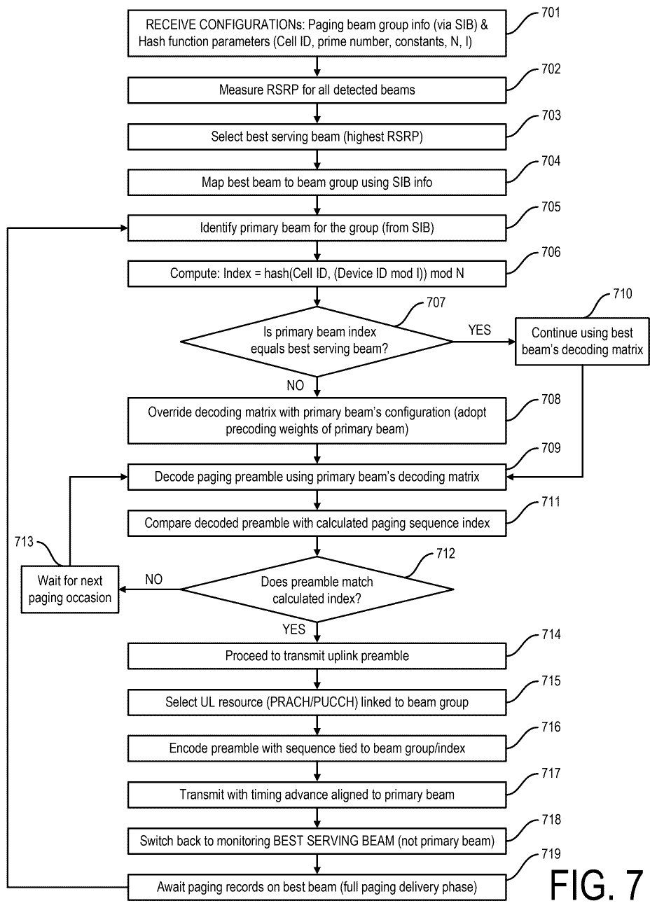

FIG. 7 is a flowchart that illustrates the overall device action logic with the proposed beam-based paging procedure where the wireless device initiates its operation by receiving the Master Information Block (MIB) and System Information Block (SIB) broadcast by the RAN node, where the MIB's presence indication field signals the availability of advanced paging parameters within the SIB 701. Upon decoding the SIB, the device acquires paging beam group information, including beam group indices, constituent beams, primary beam designations, and paging resource occasions, alongside paging detection hash function parameters such as the prime number, hash constants, and paging sequence count (N).

The device measures reference signal received power (RSRP) 702 across detectable downlink beams to identify its best serving beam 703, then maps 704 this beam to its corresponding beam group using the SIB's beam group configuration. Using the hash function formula specified in the SIB, the device computes 706 its paging sequence index by combining its Device ID, the Cell ID, and the configured prime number, applying modular operations to map the result to a preamble within the beam group's allocated subset.

The primary beam index is compared 707 to the best serving beam. If the primary beam is equal to the best serving beam, the best beam's decoding matrix is continued 710 to be used. If the primary beam of the assigned beam group differs from the best serving beam, the device temporarily overrides 708 its receiver's decoding matrix to adopt precoding weights specific to 709 the primary beam during predefined paging occasions. It monitors the primary beam's paging resources, correlating received preambles 711 with its calculated sequence index. Upon detecting a correlation exceeding a predefined margin—accounting for potential signal degradation from non-best beam monitoring—the device transmits 714 an uplink paging preamble via PRACH or PUCCH resources mapped 715 to its beam group index 716. This uplink transmission 717 triggers the RAN node to activate full paging delivery, sweeping paging records across all beams in the device's beam group.

The device immediately switches 718 to full paging detection mode, reconfiguring its receiver to monitor 719 its best serving beam for the paging record. It employs beam-specific decoding matrices to maximize signal quality, persisting in this mode until successfully decoding the paging record or reaching a SIB-configured timeout. Successful decoding terminates the process, while a timeout prompts reversion to primary beam monitoring for subsequent paging cycles. Throughout, the device dynamically adapts to SIB updates, such as prime number adjustments or beam group reconfigurations, ensuring continuous alignment with network conditions. This end-to-end timeline minimizes energy consumption by restricting initial paging to primary beams, activating full sweeps only upon confirmed device presence, and leveraging optimal beam alignment for critical phases, thereby reducing latency and resource overhead in beamformed networks.

A method performed by a Radio Access Network (RAN) node for paging indication management may comprise grouping a plurality of active downlink beams into one or more beam groups, each beam group assigned a primary downlink beam; compiling and broadcasting, via a System Information Block (SIB), paging beam group information including paging beam group and resource information; compiling and broadcasting paging detection hash function parameters including device paging grouping configurations; determining and generating, for a device to be paged, a paging sequence index using a hash function based on a RAN node cell ID, Device ID, and a configured prime number; transmitting paging indications via the primary beam of each beam group, wherein the paging indications include a preamble corresponding to the generated paging sequence; on condition of receiving one or more uplink paging preamble from one or more devices, activating full paging delivery by compiling and transmitting paging records over all beams within the paging beam groups associated with the received uplink preambles.

The primary downlink beam for each paging beam group is dynamically selected by the RAN node as the beam within the group that transmitted the largest number of paging indications over a predefined rolling period, wherein the predefined rolling period is configured as a time interval spanning a plurality of paging cycles, and wherein the RAN node continuously updates the primary beam selection based on a paging load metric derived from historical paging traffic statistics per beam.

The RAN node prioritizes beams for primary beam selection by: tracking, for each beam in the paging beam group, a cumulative count of paging indications transmitted during the predefined rolling period; comparing the cumulative counts across all beams in the group; and assigning the primary beam designation to the beam with the highest cumulative count, wherein ties between beams with equal counts are resolved by selecting the beam with superior signal quality metrics or lower interference levels.

The RAN node periodically broadcasts updated primary beam indications via the SIB upon reselection of the primary beam, and wherein devices served by the beam group are reconfigured to monitor the updated primary beam for subsequent paging occasions.

The paging beam group information comprises: a group index mapped to a plurality of beams included in the beam group, wherein each beam in the beam group is identified by at least one of a beam identifier, a primary beam indication for each beam group, explicitly signaled in the System Information Block (SIB) as a distinct field and paging resource occasion information specifying time-domain parameters including a system frame number (SFN) offset and slot offset, frequency-domain parameters including a subcarrier spacing and physical resource block (PRB) allocation, and periodicity parameters defining repetition intervals of the single paging occasion associated with the primary beam.

Compiling and broadcasting the paging detection hash function parameters comprises: a set of paging sequence preambles (S1, S2, . . . , Sn), each preamble uniquely identified by a sequence index and mapped to a distinct paging group, one or more hash function static constants configured to enable devices to compute a hash output using a combination of a Cell ID, a Device ID, and a prime number, wherein the hash static constants are predefined or dynamically generated by the RAN node, a prime number used in the hash function to minimize collision probabilities between paging sequence indices assigned to different devices, the number of available paging sequences (N), and a paging group size indication (I) defining a maximum number of devices associated with each paging sequence preamble.

The number of available paging sequences (N) is derived from a product of the paging group size indication and a total number of beam groups, ensuring that each beam group is allocated a subset of paging sequences proportional to its active device count.

The RAN node periodically updates the hash function parameters via the SIB in response to changes in network configuration, including beam group reconfiguration, Cell ID updates, or adjustments to the prime number to maintain hash output uniqueness.

Determining and generating the paging sequence index comprises: computing the index using a hash function that combines a Cell ID of the RAN node, a Device ID of the device to be paged, and a configured prime number, wherein the index is derived by applying a modulo operation to the Device ID using a predefined divisor (I) to generate a reduced Device ID value representing each paging device group, combining the Cell ID with the reduced Device ID value by multiplying the Cell ID by a scaling factor and adding the reduced Device ID value to produce a combined intermediate value, multiplying the combined intermediate value by the prime number to generate a hashed output, and applying a modulo operation to the hashed output using a divisor (N) corresponding to the number of available paging sequences to compute the final paging sequence index.

The divisor (N) is equal to the number of paging sequence preambles broadcast in the SIB, and wherein the RAN node updates the value of N dynamically based on changes in network configuration, beam group topology, or paging traffic load.

Transmitting the paging indications comprises: transmitting, via the primary beam of each beam group, a paging preamble corresponding to the generated paging sequence index, wherein the paging preamble is transmitted during the paging occasions associated with the primary beams and is encoded using a precoding matrix specific to each of the determined primary beam, and restricting transmitting paging preambles over non-primary beams unless a subsequent full paging record delivery is activated in response to received uplink paging preambles.

Upon receiving one or more uplink paging preambles from one or more devices, activating full paging delivery by compiling paging records for devices associated with the received preambles and transmitting the paging records over all beams within the paging beam groups linked to the received uplink preambles, wherein the RAN node sweeps the paging records across all beams of the associated beam groups to ensure coverage for devices with varying beam preferences or mobility states.

Activating full paging delivery includes: identifying the paging beam group associated with each received uplink preamble based on a predefined mapping between the uplink preamble sequence and the beam group index; allocating time-frequency resources for the paging record transmission across all beams of the identified beam groups, wherein the resources are orthogonalized to avoid interference between overlapping beam groups; and applying beam-specific precoding matrices to each beam within the beam group during paging record transmission, wherein the precoding matrices are optimized for beamforming gain and spatial coverage.

The RAN node terminates full paging delivery for a beam group after a predefined timeout period from the time the full paging record delivery is performed or upon receiving acknowledgment from devices successfully decoding the paging records, and reverts to transmitting paging indications solely via the primary beam of the beam group.

A method performed by a wireless device for paging detection may comprise receiving, from a RAN node, paging beam group information and paging detection hash function parameters; determining a best serving beam and a corresponding beam group with an assigned primary beam; calculating a paging sequence index using the received paging hash function parameters; overriding a current decoding matrix of the best serving beam with a decoding matrix of the primary beam of the determined paging beam group on condition if the primary beam differs from the best serving beam; monitoring the paging resource occasion of the determined primary beam for a preamble matching the calculated paging sequence; on condition of detecting a matching paging preamble, transmitting an uplink paging preamble associated with the current paging beam group; re-activating full paging detection on the best serving beam after transmitting the uplink preamble.

A wireless device may: determine a best serving beam by measuring reference signal received power (RSRP) for beams within a coverage area of the device; identify the corresponding beam group by matching the best serving beam to a beam group listed in the received paging beam group information; and calculate the paging sequence index by applying the received paging hash function parameters, including the prime number and hash static constants, to the Cell ID and Device ID in accordance with the hash function formula broadcast by the RAN node.

A wireless device may verify whether the primary beam of the identified beam group differs from the best serving beam; and override a decoding matrix of the best serving beam with a decoding matrix associated with the primary beam for the duration of the paging occasion monitoring, wherein the overriding includes adopting precoding weights or beamforming configurations specific to the primary beam.

A wireless device may monitor the single paging occasion associated with the determined primary beam of the paging beam group, wherein the paging occasion is identified using the time, frequency, and periodicity parameters broadcast in the System Information Block (SIB); decoding the paging preamble transmitted during the paging occasion using the decoding matrix of the primary beam; and detecting a match between the decoded preamble and the calculated paging sequence index by comparing the preamble identifier to the device's derived paging sequence index.

Detecting a matching paging preamble comprises: measuring a correlation threshold between the decoded preamble and the calculated paging sequence; verifying that the correlation exceeds a predefined margin to account for potential signal degradation caused by monitoring a non-best serving beam; and triggering transmission of the uplink paging preamble on condition if the correlation threshold is satisfied.

Transmitting an uplink paging preamble comprises: selecting uplink resources associated with the current paging beam group, wherein the resources are predefined in the SIB or derived from the paging sequence index; encoding the uplink preamble using a sequence linked to the paging beam group identifier or the detected downlink paging sequence; and transmitting the encoded uplink preamble with a timing advance aligned to the primary beam's paging occasion to ensure synchronization with the RAN node.

The uplink preamble is transmitted via a physical random-access channel (PRACH) resource or a dedicated paging uplink control channel (PUCCH) resource, wherein the resource mapping is predefined in the SIB or dynamically configured based on the paging beam group index.

Upon transmitting the uplink paging preamble, activating a full paging detection mode by switching to monitoring paging records on the best serving beam instead of the primary beam; and maintaining the full paging detection mode until a paging record is successfully decoded or a predefined timeout period expires.

In embodiments, beams may be grouped in sequence to each other and a paging resource may be associated to each group (rather than each beam), when a page is pending, a RAN node (e.g. whether satellite or ground RAN) may broadcast a new and improved paging message over each paging resource associated with each paging group (e.g. not all active beams), and such new paging message design is needed. For instance, some devices seeing beam x as a best beam should detect paging on a common beam y per group, which may not be the best detected beam and so, the paging message itself may be made more reliable. If a page is detected by one or more devices, they simply indicate where are they, in terms of just what beam group they belong to. For instance, if there are 1028 beams transmitted, but only 5 beam groups, devices detecting the page, may indicate one or more of the 5 paging groups. This may act as a trigger to activate standard paging sweeping, but with just only over the beam groups of interest. In an embodiment, a RAN node received true page detection indication from one or more devices of paging group 1 (e.g. that has 200 beams), the RAN sweeps the standard paging message subsequently over those 200 beams, and there may not be a reliability loss because each device may receive the standard paging message on its best serving beam. It should be noted that, in that example, instead of executing standard paging sweeping over 1028 beams, sweeped paging comprises, first over 5 primary beams (for the 5 [aging groups), and then, over the 200 beams of the determined paging groups to cover the intended one or more devices, totaling 205 beam sweepings.

Current Radio Access Network (RAN) architectures deploy AI/ML models using centralized, offline training methodologies that rely on historical or simulated data. These static models are designed under the assumption that they can generalize across all real-world network conditions. However, this approach fails to account for the dynamic, heterogeneous nature of live cellular environments, where factors such as rapid signal degradation due to mobility, unpredictable interference patterns, and localized traffic congestion create highly variable performance regions. As a result, pre-trained models quickly become obsolete, delivering suboptimal predictions for mission-critical RAN functions like beamforming optimization, handover management, and resource allocation. This inadequacy is exacerbated in future cellular network visions of AI-native networks, where real-time adaptability is paramount.

Efforts to address these limitations through continuous online training face significant barriers. For instance, retraining models on active devices conflicts with user-plane data sessions, creating signaling overhead and draining battery life. Furthermore, the diversity of device capabilities (e.g., computational power, energy reserves) and operational contexts (e.g., urban vs. rural deployments) complicates coordinated model updates. Without a mechanism to selectively engage devices during inactive periods or prioritize contributions from optimally positioned nodes, real-time training becomes inefficient and unsustainable.

U.S. Pat. No. 9,563,854 to Cruz Mota et al. titled “Distributed Model Training” is reproduced herein by reference in its entirety. Cruz Mota et al. describe a method where a device coordinates the training of a machine learning model across multiple devices within a network. Each device trains the model using its local dataset and shares the updated parameters with other devices in a sequence, facilitating collaborative model training without centralizing data.

WO2023213722 to Hojin Kim et al. titled “Advanced Wireless Communication AI/ML Training Techniques” is reproduced herein by reference in its entirety. Hojin Kim et al. discuss event-triggered and periodic approaches for AI/ML applications within radio access networks (RANs). It focuses on facilitating federated learning by distributing a global model located in the RAN or server base station to user equipment (UEs) and collecting local model feedback.

In one exemplary embodiment, a RAN node stores multiple AI/ML models each tagged with unique model and version identifiers, and initiates model distribution to a set of connected-mode WTRUs by multicasting these models over an AI-device-group-common data channel. The downlink transmission utilizes a group-common PDCCH scrambled with a group-common RNTI and formatted with a dedicated DCI field that includes the model and version identifiers. The WTRUs, pre-configured with a group-common control search space, decode the PDCCH, retrieve the model metadata, and store the received models for later local training.

In another embodiment, the RAN node triggers idle-mode training participation by broadcasting, at periodic intervals, a master information block (MIB) that indicates the availability of a specialized AI/ML idle mode training system information block (SIB). Upon decoding the MIB, eligible idle-mode WTRUs monitor for the AI/ML SIB, which includes a 1-bit training request flag and additional fields specifying the model identifier, version, and training eligibility criteria. These criteria may include device class, geographical location, mobility state, battery level, and computational load thresholds, enabling the RAN to target suitable WTRUs for distributed training while optimizing energy and network resource usage.

An embodiment at the RAN node involves configuring WTRUs with model priority values associated with AI/ML models distributed over either device-specific or group-common data channels. During each global training periodicity, the MIB broadcast includes a model priority threshold, which instructs idle-mode WTRUs to activate training for only those stored models whose priority values meet or exceed the threshold. This allows the RAN node to flexibly coordinate training across the network based on real-time needs, such as focusing on models related to beamforming or mobility prediction in specific scenarios.

On the WTRU side, an exemplary embodiment involves a device transitioning from connected to idle mode, during which it detects a MIB broadcast indicating AI/ML training availability. The WTRU decodes the corresponding AI/ML training SIB and checks whether it satisfies the eligibility criteria defined within. If eligible, it selects a locally stored model matching the received identifier and version, initializes it using a compressed quantized initialization vector (if applicable), and begins training using its locally available dataset. Upon completion, the WTRU evaluates the trained model's prediction confidence and, if it meets a predefined threshold, initiates a temporary random-access procedure using a dedicated preamble and a service cause flag indicating “AI/ML model training reporting.”

In yet another WTRU-centric embodiment, upon successful RRC connection re-establishment for AI/ML reporting, the WTRU transmits its trained model or gradients to the RAN node. Depending on available resources and data size, the model or gradient is either encapsulated in an RRC container message with metadata including the model identifier, version, and training timestamp, or segmented into multiple uplink control information (UCI) payloads with sequence numbers for reassembly at the RAN node. Alternatively, the WTRU may initiate a buffer status report (BSR) request tagged with an AI/ML-specific logical channel group (LCG) identifier, prompting the RAN to allocate dedicated uplink resources for model transmission with higher priority than standard data traffic.

Several embodiments on potential WTRU signaling are disclosed that may help the RAN in executing an efficient federated learning. It should be noted that the federated learning algorithms themselves are available in the literature including, but not limited to the following documents: “New key issue for Vertical Federated Learning between 5GC and AF for cross-domain AI/ML coordination” to Vivo et al. SA WG2 Meeting #160-Ad-Hoc-e January 22th-29th, 2024; Elbonia S2-2400560 (reproduced herein by reference in its entirety); International Publication no. WO2023086937 to Starsinic et al. (reproduced herein by reference in its entirety); “New KI on Horizontal Federated Learning” to China Mobile 3GPP TSG SA WG2 Meeting #149E S2-22xxxx Elbonia, Feb. 14-25, 2022 (reproduced herein by reference in its entirety); and International Publication no. Wo 2022/067355 to Louizos et al. (reproduced herein by reference in its entirety). Also reproduced herein by reference in its entirety is US Patent Publication no. 2022/0116764 to Pezeshki et al. Pezeshki is directed to machine learning capability reporting, grouping and updating and the techniques of Pezeshki may be relied upon herein in combination in particular at the UE/WTRU side.

In embodiments, the WTRU may compile and report attached to its sub model such that the RAN node may efficiently execute weighted federated learning. In embodiments, training epochs used by the device, data set diversity score, etc, which the higher, the higher weight the RAN node shall assign to this received sub model, etc. may be included.

A further RAN node embodiment involves aggregating AI/ML model contributions from idle-mode WTRUs using a federated averaging algorithm, wherein each contribution is weighted based on metadata such as reported prediction accuracy, size of the local training dataset, or computational effort expended. The node may segregate contributions by device class—e.g., smartphones versus IoT devices—and maintain distinct global model instances per class, each with its own versioning scheme. A new model version is generated only if the aggregated contributions satisfy a quality metric threshold such as a minimum validation accuracy or consensus level.

In embodiments, a RAN may collect intelligence from industrial equipment's/home/infra equipment's which likely have short range modern capabilities such as WIFI, but may not have cellular connectivity and wherein such intel may be helpful for and applicable to nearby devices with cellular connectivity as well. An advantage is that there is compute resources available on those devices, and the power performance may likely be stronger than smartphones, e.g., a smart WIFI-connected refrigerator for example. A RAN node may separate those types of devices in a special group since their local models are not trained over cellular links, but instead over WIFI over any short-range communication links instead, (2) assigning a virtual RNTI-alike ID for those devices for tracking and identification, etc.

Lastly, an incentive-oriented embodiment sees the RAN node embedding an incentive indicator within the AI/ML SIB, outlining multiple participation tiers linked to scheduling priority rewards. Each tier has a corresponding participation frequency threshold, requiring WTRUs to report successfully trained models a minimum number of times within a defined time window. WTRUs meeting these thresholds are granted elevated logical channel prioritization (LCP) for subsequent non-AI/ML traffic, while those falling below may be downgraded in scheduling priority, establishing a dynamic feedback loop between training participation and network QoS benefits.

Conventional distributed AI/ML model training frameworks in cellular networks rely exclusively on connected-mode wireless devices for model updates, creating a critical bottleneck in training scalability and timeliness. Devices in connected mode represent a transient subset of the network, as most user equipment (e.g., smartphones, IoT sensors) operate predominantly in idle or inactive states to conserve battery and network resources. This dependency on connected-mode participation drastically restricts the volume and diversity of training data, prolongs model convergence intervals, and delays the deployment of time-sensitive AI/ML applications such as real-time network optimization or emergency response systems. Furthermore, infrequent training cycles caused by sporadic device connectivity exacerbate model staleness, particularly in dynamic environments where data distributions shift rapidly. By limiting training to connected-mode intervals, existing systems fail to harness the vast computational potential of idle-mode devices, resulting in suboptimal model accuracy and inefficient resource utilization across the network.

Thus, retraining AI/ML models solely during connected-mode operation imposes artificial constraints on training duration and device participation, as active sessions are often brief and prioritized for user-facing tasks. In contrast, idle-mode devices, though not actively engaged in data transmission, retain untapped computational capacity and locally stored datasets that could otherwise contribute to model refinement. For instance, a smartphone in idle mode may accumulate hours of sensor data relevant to mobility prediction or energy consumption patterns, yet conventional systems discard this opportunity.

Moreover, traditional federated learning architectures inefficiently monopolize network resources by mandating connected-mode sessions for training, which compete with user data traffic and increase control-plane overhead. In contrast, idle-mode training, as proposed herein, operates asynchronously and non-intrusively by piggybacking on existing broadcast signaling (e.g., MIB/SIB) and lightweight uplink reporting mechanisms (e.g., UCI, RRC containers). This approach eliminates the need for resource-intensive RRC state transitions or dedicated bearer establishment, allowing the RAN node to aggregate gradients or model updates from thousands of idle devices with minimal scheduling contention. For example, a smart meter in idle mode can train a load-forecasting model using historical energy usage data, report gradients via preconfigured uplink resources, and return to sleep mode without disrupting its primary metering functions. Such scalability is unattainable in connected-mode-centric systems, which struggle to balance training demands with QoS guarantees for active users.

However, to perform AI/ML model training during idle mode operations, mechanisms that safely control which wireless transmit/receive units (WTRUs) may be considered eligible and are willing to participate in the training process should be considered. This arises due to the intrinsic limitations of the Radio Access Network (RAN) in acquiring real-time status or context information from WTRUs that are not actively connected or transmitting data. Though, in idle mode, WTRUs do not maintain an ongoing connection with the network, and thus the RAN lacks direct visibility into device-specific parameters such as current battery level, processing load, mobility status, or geographic location.

A Radio Access Network (RAN) node is to support distributed artificial intelligence and machine learning (AI/ML) model training in a cellular network, wherein the RAN node is configured to store one or more AI/ML models in memory, each of the stored models being uniquely identified by a model identifier and a corresponding version identifier. The model identifier may be globally unique across the network and used to distinguish among multiple AI/ML services or functions supported by the network, while the version identifier indicates the iteration or update status of the model. These identifiers enable consistent model management, selection, and traceability across distributed training instances involving heterogeneous wireless transmit/receive units (WTRUs). The stored models may correspond to different AI/ML use cases, such as traffic prediction, beamforming optimization, or anomaly detection, and the RAN node maintains metadata about each model, including its training history, applicable WTRU classes, and associated training policies.

The RAN node transmits one or more of the stored AI/ML models to WTRUs operating in a connected mode by utilizing a group-based delivery mechanism over an AI-device-group-common data channel. In embodiments, the RAN node performs multicasting of the AI/ML model data to a predefined set of WTRUs that share a common AI/ML service identifier, the service identifier being mapped to a group of devices configured to participate in training or inference for a specific AI/ML task. The multicast transmission occurs within shared physical resource blocks (PRBs) allocated to the AI-device-group-common data channel, allowing multiple WTRUs within the same multicast group to receive the same model payload efficiently. The group-common delivery approach minimizes redundant transmission overhead compared to device-specific unicast delivery and enhances scalability by enabling simultaneous distribution of models to large numbers of eligible WTRUs. The group assignment may be based on common device capabilities, task requirements, or radio conditions, and is configured during prior control signaling phases.

Specifically, the AI/ML service identifier may be provided to the WTRUs during initial connection establishment or reconfiguration procedures via dedicated RRC signaling. Specifically, the RAN node may signal the AI/ML service identifier as part of an RRC Connection Reconfiguration message, in which the identifier is associated with an AI-device-group configuration. Alternatively, the service identifier may be dynamically broadcast through system information messages, such as an extended control format element (CFE) or within an AI/ML-related SIB, particularly in scenarios involving idle-mode WTRUs prefetching model group assignments. In either case, the WTRU stores the received AI/ML service identifier and uses it to filter incoming group-common data channel transmissions corresponding to the relevant multicast group. Thus, during model delivery, the RAN node performs multicast transmission of the model payload within shared physical resource blocks (PRBs) allocated to the AI-device-group-common data channel. This enables all WTRUs assigned to the same AI/ML service identifier to simultaneously receive the same model update, avoiding redundant unicast transmissions and significantly reducing control and data plane overhead.

To facilitate the reception and decoding of AI/ML models by the target WTRUs, the RAN node further transmits corresponding downlink control information (DCI) accompanying the user-plane data. The DCI includes dedicated fields for the model identifier and the version identifier, ensuring that receiving WTRUs are able to unambiguously determine which model is being transmitted and whether it supersedes any previously received or stored versions. The DCI is formatted according to a predefined DCI format tailored for AI/ML model signaling, wherein fields related to model identification are prioritized over conventional control fields, such as scheduling grants or HARQ process numbers. This prioritization enables rapid parsing and early model identification by the WTRUs, allowing them to prepare appropriate processing resources or discard irrelevant transmissions. The model identifier in the DCI also enables validation against local eligibility policies, ensuring that each WTRU only processes model data relevant to its configured service roles and participation preferences.

To efficiently coordinate AI/ML model distribution and control signaling, the RAN node organizes AI-capable WTRUs into one or more AI training groups based on common radio conditions, particularly their association with the same downlink beam. Each AI training group is assigned a group-common control search space configuration and a corresponding group-common Radio Network Temporary Identifier (RNTI), which are used to facilitate efficient and synchronized signaling. When the RAN node transmits AI/ML models over the AI-device-group-common data channel, the associated downlink control information (DCI) is transmitted via a group-common Physical Downlink Control Channel (PDCCH) that is scrambled using the group-common RNTI. This enables only those WTRUs within the AI training group to successfully descramble and decode the DCI, thereby isolating the signaling to a specific subset of WTRUs and avoiding unnecessary processing by other devices. This method reduces control channel congestion, optimizes resource utilization, and provides group-specific control flexibility tailored to the AI/ML model training context.

Alternatively, to the AI model ID and version, the RAN node may assign a model priority indication to each stored AI/ML model and may communicate this priority information to connected-mode WTRUs using either a device-specific data channel or the AI-device-group-common data channel. The model priority indication is used by the WTRUs to rank or filter the received models according to network training strategies or device-specific constraints. To extend this configuration to idle-mode WTRUs, the RAN node broadcasts a master information block (MIB) during a defined global AI/ML model training periodicity, and this MIB includes a model priority threshold value. The model priority threshold instructs idle-mode WTRUs to selectively activate and train only those AI/ML models stored locally with a priority value equal to or exceeding the broadcast threshold. This mechanism ensures that the most critical or time-sensitive models are prioritized for training across the network, even when devices are not actively connected, while also minimizing energy and processing overhead by suppressing training of lower-priority models.

Further refining model prioritization, the RAN node associates each model priority indication with a predefined AI/ML task category that reflects the functional purpose of the corresponding model. These task categories may include, for example, beamforming optimization, handover prediction, or traffic load balancing, each representing distinct domains of network intelligence enhancement. By mapping model priority levels to specific task categories, the RAN node enables differentiated training strategies across connected-mode and idle-mode WTRUs based on real-time network performance needs and service objectives. This association also allows WTRUs to make informed decisions about which models to train or report on, based on their own capabilities and relevance to the task. Moreover, task-category-based prioritization facilitates granular control over distributed training workloads and supports the evolution of AI/ML functionalities in a modular, scalable manner.

In one embodiment, a Radio Access Network (RAN) node may extend federated AI/ML participation to SIM-less devices by enabling participation over trusted non-cellular access, such as secure Wi-Fi or Ethernet connections. These devices may register with the network using alternative identifiers, such as device hardware IDs, MAC addresses, manufacturer-assigned certificates, or platform root-of-trust mechanisms. Such identifiers may be stored in a secure registry that maps them to virtual WTRU profiles, thereby allowing the RAN node to treat SIM-less devices as authenticated federated learning nodes. Thus, the RAN node enables the Wi-Fi-connected devices to participate in the AI/ML training lifecycle by training locally on edge data and reporting trained models or gradients to the cellular network via intermediary Wi-Fi APs linked to the RAN or core network through a trusted access gateway.

To ensure data integrity and secure aggregation, the RAN node may assign a virtual radio network temporary identifier (v-RNTI) to each SIM-less device upon registration, and use secure transport channels (e.g., TLS tunnels over IP) for delivering AI/ML models and receiving gradient updates. Federated averaging contributions from SIM-less devices can be weighted similarly to those of SIM-based devices, based on reported metadata such as local training dataset size, training time, or device trust level.

When a sim-less, e.g., Wi-Fi connected, device completes local training of a designated AI/ML model, it generates a metadata-enriched contribution payload comprising the model identifier, version number, training metadata (e.g., prediction confidence, sample size, compute cost), and either the full trained model or incremental gradient updates. This payload is securely transmitted to the RAN node via the Wi-Fi AP and AI/ML gateway interface. The RAN node processes the received contributions alongside those from conventional cellular WTRUs during the federated averaging cycle.

To distinguish these contributions and maintain model integrity, the RAN node may tag Wi-Fi-sourced updates with a special class identifier (e.g., “WiFiEdge”), allowing segregation and targeted aggregation of models for Wi-Fi devices. This class-based model segregation allows the RAN node to maintain separate global model instances for Wi-Fi devices, optimized to the data characteristics and usage patterns found in non-cellular environments.

Additionally, the AI/ML idle mode training SIB may be extended with a “SIM-LESS, e.g., Wi-Fi, Gateway Participation Indicator,” signaling the availability of training participation over non-cellular trusted interfaces. This enables Wi-Fi APs or cloud management controllers to prefetch model initialization vectors, eligibility criteria, and versioning instructions and disseminate them to eligible local devices through local service announcements or Wi-Fi-specific control frames.

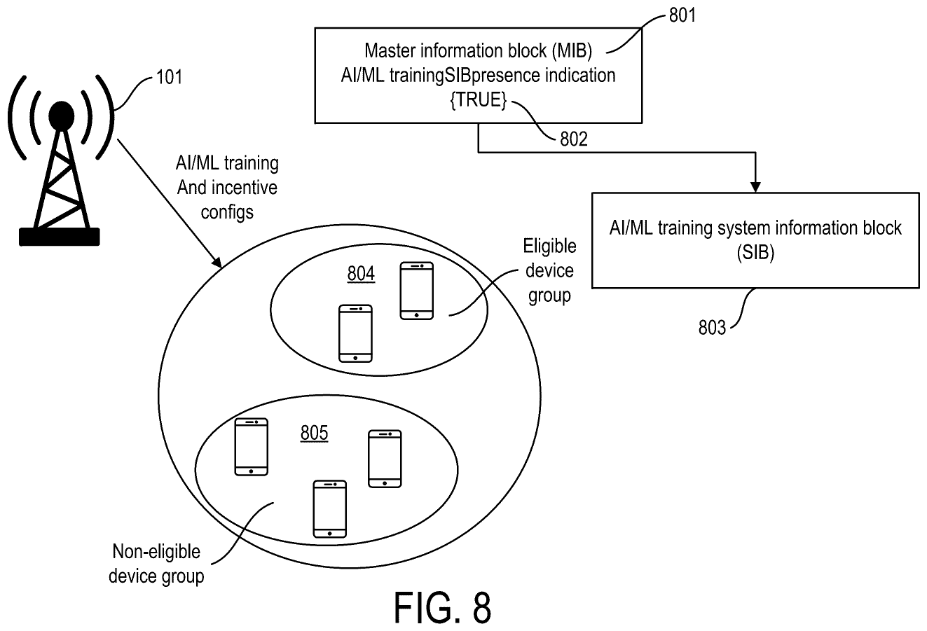

As shown by FIG. 8, during a globally defined AI/ML model training periodicity or triggered by preset real-time performance thresholds, a Radio Access Network (RAN) node 101 initiates system-wide signaling by broadcasting a master information block (MIB) that includes an indicator 802 flagging the availability of a specialized system information block (SIB) 803 designated for AI/ML idle mode training. This MIB signaling mechanism ensures that all idle-mode wireless transmit/receive units (WTRUs) monitoring the broadcast channel are made aware of upcoming AI/ML training opportunities and can prepare to receive further details contained in the AI/ML idle mode training SIB 803. The timing of the MIB broadcast 801 is synchronized across cells to align training cycles, enabling coherent distributed training activity and reducing signaling collisions or training redundancies among idle-mode WTRUs that may be scattered across different cells but are eligible for the same training session.

Following the MIB indication 801, the RAN node transmits the AI/ML idle mode training SIB 803, which includes AI/ML training eligibility configurations to enable precise selection of idle-mode WTRUs that may participate in distributed training. The SIB is structured to contain parameters defining the conditions under which a WTRU may engage in training, such as geographical constraints, battery thresholds, device class restrictions, or mobility criteria. This structured signaling approach allows the RAN node to broadcast a single SIB applicable to many devices while allowing each idle-mode WTRU to independently determine its own eligibility based on its current status and capabilities. Such a mechanism reduces the need for per-device signaling, thereby conserving network resources while ensuring that only suitable devices contribute to model training, enhancing the quality and reliability of aggregated model updates.

In the example shown, WTRUs 804 belong to an eligible device group. WTRUs 805 belong to a noneligible device group.

In one embodiment, the RAN node may designate a subset of UEs-such as those classified as low-duty-cycle IoT devices, wearable sensors, or energy—constrained mobile terminals—to acquire the AI/ML training SIB only upon explicit request or based on a triggering event. This request could be initiated by the UE through a lightweight RRC signaling exchange or an uplink message transmitted using a reserved scheduling request (SR) or short control signaling. In this approach, the UE first detects a general-purpose SIB or control format element (CFE) indicating the availability of AI/ML training configuration information, and then initiates a request to retrieve the specific training SIB contents when it determines that local conditions (e.g., sufficient battery, stationary location, or scheduled idle-time processing availability) make participation feasible.

In another embodiment, the SIB may be segmented into two portions: a minimal header section broadcast periodically, indicating whether updated AI/ML training eligibility configurations are available, and a detailed content section delivered only upon UE request or during preconfigured windows. This segmented approach balances broadcast efficiency with the flexibility of on-demand retrieval and can be particularly effective in heterogeneous deployments involving both frequently active smartphones and intermittently connected AI-capable IoT devices.

To further streamline idle-mode WTRU behavior and minimize unnecessary power consumption, the AI/ML idle mode training SIB includes a 1-bit AI idle mode training request indication flag. This flag serves as a lightweight preamble to the more detailed content of the SIB, where the flag is set to a predefined value that explicitly signals idle-mode WTRUs to proceed with decoding the remaining SIB fields. If the flag is not set, WTRUs may disregard the rest of the SIB payload, thereby saving processing resources and extending battery life. This design provides a low-overhead mechanism to trigger targeted training participation and avoids burdening devices with unnecessary decoding tasks during periods when training is not applicable or when no eligible models are scheduled.

Within the AI/ML idle mode training SIB, the model identifier and version identifier of the AI/ML model designated for idle mode training are included in a dedicated field that is formatted to prioritize model identification. This ensures that idle-mode WTRUs can rapidly recognize whether the model referenced in the SIB corresponds to any locally stored model copy, thereby enabling an immediate training decision without extensive processing. The model identifier used in this field is globally unique and corresponds to an AI/ML service identifier registered in the cellular network, ensuring that there is no ambiguity in model recognition across different RAN nodes or training sessions. The version identifier complements the model identifier by distinguishing between iterative updates of the same base model, allowing WTRUs to synchronize their local copies and prevent stale training contributions. This explicit and prioritized model identification mechanism ensures efficient, accurate training execution and consistent model version tracking across the network.

The eligibility criteria included in the AI/ML idle mode training system information block (SIB) transmitted by the Radio Access Network (RAN) node may include predefined geographical coordinates defining a geographic area for training participation. These coordinates may be expressed as explicit GPS boundary points or through a coverage area identifier such as a tracking area code (TAC) or cell global identity (CGI). Idle-mode wireless transmit/receive units (WTRUs) located outside the designated geographic area are excluded from participating in the training session, thereby ensuring that only data and training contributions relevant to a specific environmental, network, or service context are utilized. This location-based filtering improves the contextual accuracy of distributed AI/ML model updates and prevents skewing of the model by including inputs from WTRUs operating under dissimilar conditions.

In addition to geographical constraints, the eligibility criteria may include a minimum battery capacity threshold, wherein only idle-mode WTRUs with available battery capacity exceeding the specified threshold are permitted to participate in training. The RAN node may dynamically adjust the battery threshold based on historical training participation rates, average energy consumption trends, or network-wide energy-saving policies. For instance, if training participation from devices with low battery levels has historically resulted in premature termination or reduced quality updates, the RAN node may increase the threshold to favor devices with more stable energy availability. Conversely, during critical model update cycles, the threshold may be relaxed to increase the training pool, with the trade-off managed via network-level policies. This energy-aware eligibility configuration balances model quality with device longevity and overall user experience.

In a further embodiment, the battery capacity eligibility criterion signaled by the RAN node in the AI/ML idle mode training system information block (SIB) is supplemented by an indication of the WTRU's real-time charging context. The WTRU evaluates its battery level against the minimum battery capacity threshold included in the SIB; however, this evaluation is further qualified by internal indicators that reflect whether the WTRU is currently charging via a wireless or wired power source, and the estimated charging rate. A WTRU that is currently charging, or connected to a high-speed charger, may override a local battery constraint flag and elect to participate in distributed model training even if its nominal battery level is below the threshold.

To facilitate this behavior, the WTRU transmits an AI/ML Training Capability Report to the RAN node, which includes a charging status indicator field. This field is encoded using predefined values that differentiate among: (1) no charging, (2) charging (standard rate), (3) charging (fast rate). Optionally, the report may also include an estimated time-to-full-charge metric, computed locally by the WTRU's power management subsystem. This data is sent over the air via radio resource control (RRC) signaling, uplink control information (UCI), or as part of a scheduled uplink data transmission depending on WTRU state.

The RAN node, upon receiving the charging status metadata, dynamically modifies the eligibility decision logic. For instance, if a WTRU reports being on a fast charger, the RAN node may temporarily waive the minimum battery threshold requirement for that WTRU. Conversely, WTRUs reporting no charging and battery levels near the cutoff may be deprioritized. The SIB may also include a “charging status override enable” parameter, signaling whether devices in any of those charging states are permitted to bypass battery-level constraints.

The eligibility configuration further includes a maximum processing load threshold defined as a percentage of a WTRU's total computational capacity. This processing load threshold ensures that only WTRUs operating below a specified level of CPU or GPU utilization are selected for idle mode training, thereby avoiding overburdening devices already engaged in background processes or system-critical functions. The RAN node may periodically update this threshold based on previously reported device capabilities, usage patterns, or AI/ML task complexity. In this manner, the network tailors its training demands to the actual capabilities and current status of each WTRU, maintaining efficient operation without interfering with primary device functions.

Mobility state is also considered within the eligibility criteria, wherein a mobility state threshold may be specified to include only WTRUs that exhibit low or stationary movement characteristics. The threshold may be expressed as a maximum velocity, such as in kilometers per hour, or a handover frequency limit per unit time. WTRUs exceeding this threshold—indicating high-speed movement or frequent cell transitions—are excluded from training participation. This exclusion improves training consistency by focusing on devices that are likely to remain under stable radio conditions throughout the duration of their training session, thus reducing disruptions and increasing the reliability of local model updates.

Eligibility criteria may include predefined device classes that categorize WTRUs based on their hardware capabilities or usage profiles. Device classes may encompass smartphones, IoT devices, vehicular user equipment, wearables, or fixed-location terminals, among others. The RAN node selectively enables training participation only for WTRUs belonging to specified classes depending on the target AI/ML task. For instance, vehicular user equipment may be prioritized for traffic prediction models, while smartphones may be prioritized for beamforming optimization. This class-based selection mechanism enhances the task-specific relevance of the training dataset and aligns the model learning process with the expected operational context of participating devices.

Transmitting the AI/ML idle mode training system information block (SIB) further comprises including a compressed model initialization vector to support efficient model instantiation on idle-mode wireless transmit/receive units (WTRUs) lacking a previously stored version of the AI/ML model. The initialization vector is a compact representation of the base model parameters generated using a quantization technique, such as k-means clustering, fixed-point encoding, or dimensionality reduction through matrix factorization.

By using such compression schemes, the initialization vector significantly reduces the downlink payload size while preserving essential model characteristics, enabling bandwidth-efficient signaling over the broadcast channel. Idle-mode WTRUs that do not possess any local model version extract the initialization vector from the SIB and use it to construct a functional representation of the AI/ML model suitable for localized training or inference. This approach ensures that participation in distributed training is not restricted solely to devices with full model download history, thus broadening the potential training pool and reducing reinitialization overhead.

Moreover, the AI/ML model training depth configurations included in the idle mode training SIB specify different levels of training tasks based on device-specific resource constraints, allowing the Radio Access Network (RAN) node to orchestrate a heterogeneous yet coordinated training process. The training depth configuration distinguishes between full local model training and partial gradient update participation. WTRUs that meet or exceed a minimum battery capacity threshold and operate under a maximum processing load threshold may be instructed to perform full local model training, involving multiple epochs over locally available data with parameter updates computed end-to-end.

Conversely, WTRUs operating below the battery threshold or above the processing load threshold may be instructed to perform reduced training tasks, such as calculating partial gradients over a subset of the model layers or over a smaller portion of local data. These WTRUs may then upload partial update vectors to the network, contributing to the model aggregation process with lower computational and energy demands. This tiered training depth mechanism enables intelligent workload distribution and allows even resource-constrained devices to contribute meaningfully to federated model improvement while respecting their operational limitations.

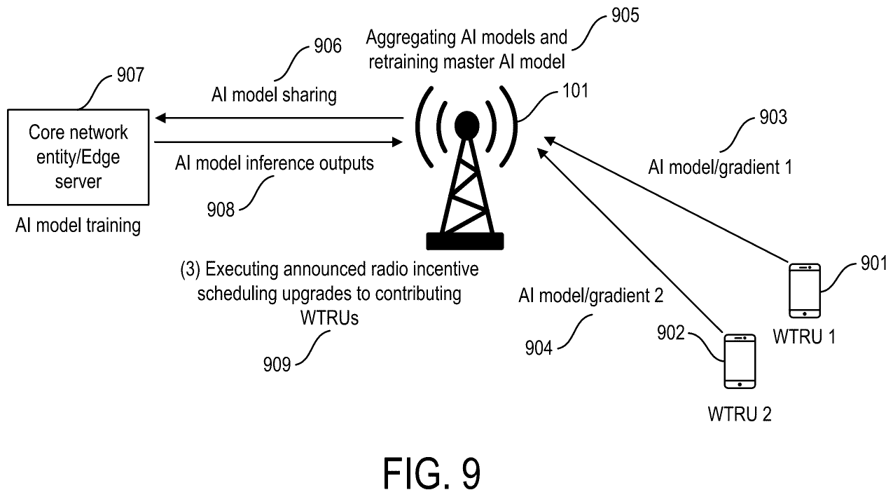

As depicted by FIG. 9, a RAN node 101 may receive trained AI/ML models or corresponding gradients 903, 904 from idle-mode wireless transmit/receive units (WTRUs) 901, 902. This may be accomplished using at least one of radio resource control (RRC) signaling, uplink control information (UCI), or scheduled uplink data channels. When uplink resources are granted to idle-mode WTRUs following successful eligibility verification and local training execution, the WTRUs transmit the model updates in a compact format using scheduled physical uplink shared channel (PUSCH) allocations.

In scenarios where low-latency reporting is prioritized, WTRUs 901, 902 may embed partial gradient vectors or training summary statistics within UCI formats extended for AI model coordination. Additionally, RRC signaling extensions enable delivery of training metadata such as model version, training duration, and resource usage to support aggregation decisions at the network side. The RAN node 101 continuously monitors these multiple reporting mechanisms and consolidates the received contributions for downstream model aggregation. To distinguish between full and partial updates or between prioritized model categories, WTRUs 901, 902 may include identifier tags aligned with the AI/ML model ID and version indicated in the training SIB.

The RAN node 101 may aggregate 905 and retain the received trained models or gradients to generate a globally updated AI/ML model is performed using a federated averaging algorithm at the RAN node, with dynamic weighting based on WTRU-specific contribution metrics. Each received update from an idle-mode WTRU is first validated against the model identifier and version it corresponds to, ensuring alignment with the current training cycle. The federated averaging process then applies weight assignments to each WTRU contribution based on one or more reported or inferred parameters.

The RAN node 101 may share 906 AI models with a core network entity or edge server 907 which provides AI model inference outputs 908. The RAN node may execute radio incentives and schedule upgrades 909 to contributing WTRUs, e.g. WTRUs 901, 902.

These parameters may include the prediction confidence scores generated by the WTRU's local model on held-out validation data, the number of local data samples used during training, and the computational energy expended during the training process. By assigning higher weights to more robust and resource-intensive updates, the RAN node ensures that the resulting globally updated model reflects the most reliable training inputs. Once aggregation is complete, the version identifier associated with the model is incremented to reflect the updated state, and the new model may be broadcasted or scheduled for dissemination in subsequent training cycles.

Incrementing the version identifier of the globally updated AI/ML model is conditional upon the aggregated trained models or gradients satisfying a predefined quality metric established by the RAN node to ensure model robustness and generalizability. The quality metric may be derived from a validation process wherein the aggregated model is tested against a standardized dataset or synthetic validation inputs to assess prediction accuracy. If the validation accuracy fails to exceed a configured threshold, the version increment is deferred, and the RAN node may solicit additional training contributions.

In other embodiments, the quality metric includes a minimum number of idle-mode WTRUs participating in the current training cycle, wherein a quorum of contributors may be helpful to ensure sufficient model diversity and representation. Alternatively, or additionally, a consensus threshold may be calculated based on the statistical similarity or convergence of gradients received from different WTRUs. If the gradient vectors deviate significantly beyond a preconfigured norm threshold, the RAN node may reject or partially weight such contributions and delay the model version update. In embodiments, only when the combined validation accuracy, contributor count, and contribution alignment surpass the threshold criteria does the RAN node increment the model version identifier and update the version control database for distribution in subsequent training rounds.

Aggregating the received trained models or gradients further includes segregating contributions based on the device class of the WTRU to optimize model specialization and applicability across heterogeneous device types. The RAN node first classifies idle-mode WTRUs into predefined device classes, such as smartphones, IoT sensors, vehicular UEs, or AR/VR terminals, based on capability reports, service subscriptions, or broadcast identifiers. During the aggregation phase, contributions from each device class are processed separately, and distinct federated learning operations are performed to yield class-specific global models. Each class-specific global model is assigned a unique version identifier, maintained independently from other device classes, allowing parallel evolution of specialized models tailored to their operational constraints and data modalities. For example, a vehicular UE model may emphasize mobility prediction and latency mitigation, while an IoT sensor model may focus on energy-efficient anomaly detection. This segregation strategy ensures higher model relevance and reduces generalization errors that may arise from aggregating heterogeneous device behaviors into a single global model.

In an extended embodiment, contributions to federated learning may not be limited to uplink transmissions from individual WTRUs to the RAN node. Instead, a subset of WTRUs—such as vehicular UEs, AR/VR terminals, or high-capability smartphones—may participate in cooperative federated learning via device-to-device (D2D) communication using sidelink signaling. The RAN node, upon classifying device types and geographic proximity, may configure one or more WTRUs to serve as local model aggregators within a cooperative training cluster. The cluster members exchange their locally trained AI/ML models or corresponding gradients over the sidelink interface (e.g., PC5 or NR sidelink).

The RAN node may also broadcast sidelink training configuration parameters via a dedicated system information block (e.g., an AI/ML cooperative training SIB) or include them in a unicast or multicast RRC message. These parameters specify the sidelink cluster identifier (e.g., group), cluster member list, model metadata such as version identifier. Devices use the provided configurations to discover nearby cooperative peers, establish secure sidelink communication sessions, and perform pairwise or group-level model exchanges.

Once the local model exchange is complete, one designated WTRU (e.g., the aggregator or the device with highest computational capability) performs intermediate model aggregation using a localized federated averaging algorithm. The resulting pre-aggregated model is then transmitted to the RAN node, tagged with a cooperative training flag and accompanying metadata, such as contributor IDs, weight factors, and local aggregation confidence scores. This offloads part of the aggregation effort from the RAN and may reduce backhaul congestion when multiple nearby devices train on highly correlated datasets.

The RAN node further transmits an incentive indicator to idle-mode WTRUs via the AI/ML idle mode training system information block (SIB), which specifies multiple participation incentive levels that provide an upscaled scheduling priority for network resource allocation to WTRUs that contribute by executing and reporting trained AI/ML models or their corresponding gradients. The incentive indicator effectively motivates WTRUs to participate in the distributed AI/ML training process by offering them enhanced network access in return for valuable model updates. WTRUs that submit higher-quality or more frequent AI/ML model contributions are tracked by the RAN node, which then assigns a corresponding scheduling priority level based on the amount and quality of the reported AI/ML model contributions. The RAN node ensures that active contributors are rewarded with a higher chance of receiving preferential treatment for other network resources, such as data scheduling or traffic handling, which encourages continued participation and more frequent contributions to the AI/ML model training process.

The RAN node further enhances the participation incentive system by including a participation frequency threshold in the AI/ML idle mode training SIB for each incentive level. This threshold specifies a minimum number of successful AI/ML model training reports required from a WTRU within a predefined time window to qualify for a specific scheduling priority level. If a WTRU fails to meet the participation frequency threshold—indicating insufficient contribution to the AI/ML training process—the RAN node downgrades the scheduling priority level for that WTRU. This mechanism ensures that only WTRUs that consistently contribute to the AI/ML model training process are rewarded with higher network resource priorities, while those that are less active or fail to meet the threshold may experience reduced priority, incentivizing them to participate more frequently in future training cycles.

For each participation incentive level, the scheduling priority level is implemented as a modified logical channel prioritization (LCP) configuration, where the RAN node assigns a unique LCP priority value to each incentive level. This LCP configuration allows the RAN node to prioritize uplink transmissions from WTRUs that have successfully reported AI/ML model training results. When WTRUs with higher incentive levels send non-AI/ML data after contributing to the training, they can use the higher LCP priority to ensure that their uplink transmissions are scheduled with higher priority and potentially lower latency. This dynamic prioritization scheme ensures that contributors who have provided valuable training updates continue to experience network advantages, which further incentivizes WTRUs to contribute to the ongoing AI/ML model refinement and training efforts.

In order to prevent starvation of lower-priority AI/ML models during distributed training across wireless transmit/receive units (WTRUs), a dynamic priority balancing mechanism may be implemented by the RAN node. Rather than assigning static priority levels to each AI/ML model, the RAN node may maintain a model participation fairness index (MPFI) for each model, which is periodically updated based on the historical frequency of training participation and contribution volume for that model across the network. When determining which models to broadcast or request for training during a given training cycle, the RAN node may utilize a weighted scheduling algorithm that incorporates both the model's original priority indication and its current MPFI, ensuring that underrepresented models are more likely to be selected for transmission in future training rounds.

Specifically, the Model Participation Fairness Index (MPFI) may be defined as a dynamic metric computed and maintained by the RAN node for each active AI/ML model stored in the network's distributed training registry. The MPFI quantifies the relative fairness in training participation for each model over time, incorporating multiple parameters such as the number of unique WTRUs that have contributed model updates, the recency and frequency of model-specific training cycles, and the volume or quality of updates received. A lower MPFI value may indicate that a model is at risk of starvation, meaning it has been underrepresented in recent training rounds, while a higher MPFI suggests that a model has had adequate participation. The RAN node may periodically compute the MPFI using a sliding time window and apply normalization across all tracked models to ensure comparability. In turn, the MPFI may be used as a scheduling weight multiplier in a weighted round-robin or fairness-aware scheduler that determines which models are broadcast for training in upcoming periodicity windows.

To enforce and monitor such fairness policies in real time, the RAN node may utilize an Extended Control Format Element (CFE) within the downlink control information (DCI) payload associated with AI/ML model transmissions. The extended CFE may contain a starvation prevention flag and one or more subfields defining per-model fairness quotas, MPFI thresholds, or override conditions. For instance, a CFE may indicate that the model being transmitted is currently below a minimum MPFI threshold, thereby signaling WTRUs to prioritize training and reporting for that model. In other embodiments, the CFE may include a “fairness override” indicator that instructs eligible WTRUs to disregard static priority rules temporarily and participate in training a model designated for urgent fairness recovery. The use of extended CFEs allows the RAN node to flexibly convey fairness-related control decisions without overloading standard system information broadcasts, and to adjust per-model scheduling logic dynamically in response to participation trends observed across the network.

On the wireless transmit/receive unit (WTRU) side, a method for participating in distributed AI/ML model training in a cellular network is implemented by first receiving and storing one or more AI/ML models from a Radio Access Network (RAN) node. This can occur through either a device-specific data channel or an AI-device-group-common data channel, ensuring that the WTRU receives the most relevant models based on its specific role or group assignment within the network. Upon transitioning into an idle mode state, the WTRU detects the presence indication of an AI/ML idle mode training system information block (SIB) via a broadcasted master information block (MIB). The presence of this indication serves as a signal that the WTRU is eligible to participate in model training during idle mode. Following this detection, the WTRU proceeds to receive the AI/ML idle mode training SIB, which contains specific configurations, including eligibility criteria, model identifiers, version identifiers, and other parameters required to perform the training.

After receiving the AI/ML idle mode training SIB, the WTRU begins executing the training of the stored AI/ML model using its device-specific data samples. These data samples can include local measurements or sensor data collected by the WTRU during its normal operation. The WTRU trains the AI/ML model by applying these samples to the model's algorithm, updating the model's parameters based on the data it processes. During the training process, the WTRU evaluates the prediction confidence or accuracy of the trained model to assess how well it is performing in real-time conditions. This evaluation ensures that the model's predictions align with the actual observed data, allowing the WTRU to adjust its local training parameters to improve model performance. The confidence or accuracy evaluation is crucial for determining whether the model has achieved sufficient training quality to contribute meaningful gradients or updates back to the network.

Once the current training cycle is completed, the WTRU prepares the resulting trained model or gradient data for submission to the RAN node. If the WTRU meets the predefined eligibility criteria for contributing to the global AI/ML model update, it will initiate the process to transmit the trained model or corresponding gradients back to the RAN node via the appropriate uplink channels, such as radio resource control (RRC) signaling or uplink control information (UCI). This contribution may be aggregated with those from other participating WTRUs to generate an updated version of the AI/ML model. Additionally, the WTRU can prioritize its own training based on the availability of network resources, ensuring that the trained model or gradient is transmitted efficiently while adhering to the scheduled uplink data channel constraints. In this way, the WTRU plays a vital role in the distributed AI/ML training ecosystem, enhancing the overall network's ability to adapt and improve through collaborative learning across idle-mode WTRUs. The training process may be iterative.

When the prediction confidence or accuracy of the trained AI/ML model meets a predefined threshold, the wireless transmit/receive unit (WTRU) triggers a temporary random-access procedure to report its AI/ML model training progress to the Radio Access Network (RAN) node. This procedure is initiated by sending a service cause indication of ‘AI/ML model training reporting,’ which signifies that the WTRU is ready to transmit its trained model or corresponding gradients to the RAN node. The service cause indication ensures that the RAN node can prioritize the WTRU's reporting request over other unrelated traffic, thus streamlining the network's management of resources for AI/ML model training purposes. The WTRU selects an appropriate uplink channel to transmit this information, which may include radio resource control (RRC) signaling, uplink control information (UCI), or a scheduled uplink data channel, depending on the network configuration and the timing of the random-access procedure.

In one embodiment, triggering the temporary random-access procedure with the service cause indication of AI/ML model training reporting involves encoding the service cause in a radio resource control (RRC) connection request message or within the Msg3 payload of a random-access channel (RACH) procedure. The service cause is mapped to a predefined value within a dedicated field of the message, enabling the RAN node to recognize the specific purpose of the request and prioritize its processing. This dedicated service cause indication ensures that the WTRU's AI/ML training report is handled promptly without requiring the establishment of a quality of service (QoS) profile, which would otherwise introduce unnecessary delays. By directly associating the service cause with AI/ML model training reporting, the WTRU ensures that its uplink data, including trained models or gradients, is processed with minimal latency.

Further, the method includes selecting a dedicated random-access preamble specifically reserved for AI/ML model training reporting. This dedicated preamble is signaled to the WTRU within the AI/ML idle mode training system information block (SIB), which is broadcasted by the RAN node. The dedicated preamble allows the WTRU to uniquely identify its request for model training reporting during the random-access procedure, ensuring that the RAN node can distinguish this type of request from other regular random-access requests. By using a dedicated preamble, the network can efficiently manage and allocate resources for AI/ML model training without interfering with other communication processes. This approach provides a streamlined and efficient method for WTRUs to participate in the AI/ML model training process, ensuring timely reporting and integration of the trained models or gradients into the globally updated AI/ML model.

Accordingly, when transmitting the trained AI/ML model or corresponding gradients via radio resource control (RRC) signaling, the wireless transmit/receive unit (WTRU) encapsulates the model or gradients within an RRC container message. This container message is formatted to include essential metadata, which helps the Radio Access Network (RAN) node properly identify and process the transmitted data. The metadata within the container message typically comprises the model identifier, which uniquely identifies the specific AI/ML model being reported, the version identifier that ensures the RAN node knows the most recent version of the model, and a timestamp indicating when the local training session occurred. The inclusion of this metadata allows the RAN node to efficiently manage model versions, track the timing of training updates, and apply appropriate versioning or synchronization techniques when aggregating contributions from multiple WTRUs.

In another embodiment, transmitting the trained AI/ML model or corresponding gradients via uplink control information (UCI) involves segmenting the model or gradients into multiple UCI payloads that are transmitted over consecutive uplink subframes. Each UCI payload is accompanied by a sequence number, which enables the RAN node to reconstruct the complete model or gradients once all of the segments have been received. This approach ensures that large models or gradients, which may not fit into a single uplink transmission, are broken into manageable pieces for efficient transmission across the network. The sequence numbering mechanism guarantees that the RAN node can correctly order and assemble the segmented payloads, even if some payloads are delayed or arrive out of sequence. By segmenting the model or gradients and providing sequence numbers, the WTRU can reliably transmit large-scale AI/ML data without overloading the network's available transmission resources.

Alternatively, when transmitting the trained AI/ML model or corresponding gradients via a scheduled uplink data channel, the WTRU dynamically requests uplink resources by sending a buffer status report (BSR) flagged with an AI/ML-specific logical channel group (LCG) identifier. This LCG identifier informs the RAN node that the request pertains to AI/ML model training data, signaling the network to prioritize the resource allocation for this specific type of traffic over other non-AI/ML communication. The RAN node, upon receiving the flagged BSR, can then allocate the necessary resources with higher priority to ensure timely transmission of the AI/ML data. This prioritization helps optimize network performance during distributed AI/ML model training by ensuring that WTRUs can transmit their model updates or gradients without being delayed by other, less critical traffic. The use of an AI/ML-specific LCG enables the network to efficiently manage AI-related traffic and avoid congestion or delays that could impact the overall AI/ML training process.

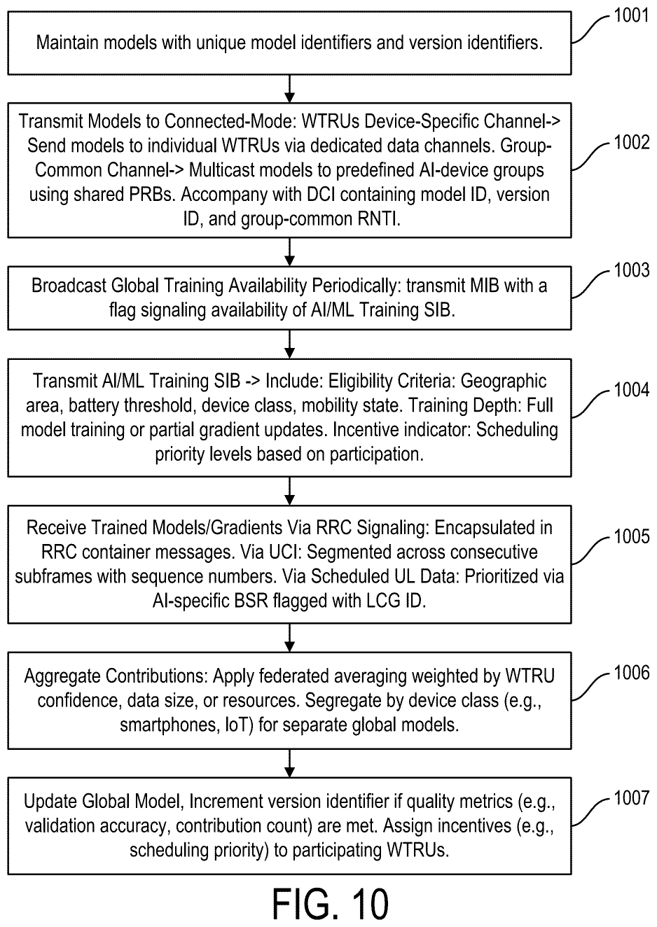

As depicted by FIG. 10, the overall RAN sequential action steps are shown where the RAN node begins by storing 1001 one or more AI/ML models, each associated with a model identifier and a version identifier. These models are stored within the network's infrastructure and are made available for transmission to the wireless transmit/receive units (WTRUs). Once the models are stored, the RAN node proceeds to transmit 1002 the AI/ML models to connected-mode WTRUs via a multi-casting mechanism. This transmission occurs over the AI-device-group-common data channel, with the models encapsulated in the data and accompanied by downlink control information (DCI). The DCI includes essential details such as the model identifier and version identifier, ensuring that the receiving WTRUs are aware of the correct version and model they need to utilize.

To further enhance the process, the RAN node groups AI-capable WTRUs that are served by the same downlink beam into one or more AI training groups. Each of these groups is assigned a group-common control search space configuration and a group-common radio network temporary identifier (RNTI). The RAN node transmits the AI/ML models via the AI-device-group-common data channel, with the group-common physical downlink control channel (PDCCH) being used to transmit the DCI, scrambled using the group-common RNTI. This allows the WTRUs in the assigned AI training group to decode the DCI within the designated control search space and participate in model training.

Following the transmission of AI/ML models, the RAN node broadcasts 1003 master information block (MIB) signaling that indicates the availability of an AI/ML idle mode training system information block (SIB). This SIB contains configurations that outline the eligibility criteria for idle-mode WTRUs to participate in AI/ML training. The RAN node transmits the AI/ML idle mode training SIB 1004, which includes detailed configurations that determine whether a particular idle-mode WTRU is eligible for participation in the training process based on factors such as geographical location, battery capacity, and processing load.

Once the configurations are broadcast and received 1005 by the idle-mode WTRUs, these devices execute training of the AI/ML models using locally collected data samples. During this training phase, the WTRUs evaluate the prediction confidence or accuracy of their trained models. When the trained model meets a predefined accuracy threshold, the WTRU triggers a temporary random-access procedure with a service cause indication of “AI/ML model training reporting.” The WTRU encodes this service cause in the radio resource control (RRC) connection request or within a message in the random-access channel (RACH) procedure, ensuring that the RAN node prioritizes the processing of the training report without establishing a full quality of service (QoS) profile.

The RAN node then receives the trained AI/ML models or corresponding gradients from the idle-mode WTRUs via RRC signaling, uplink control information (UCI), or a scheduled uplink data channel. These contributions are aggregated using a federated averaging algorithm, where the contributions are weighted based on factors such as the prediction confidence, the data sample size, and the computational resources used during training. This aggregation results in the creation of a globally updated AI/ML model.

Accordingly, in one further embodiment, WTRUs participating in distributed AI/ML model training transmit local model updates or corresponding gradients to the radio access network (RAN) node along with aggregation metadata. The aggregation metadata is included to support a federated averaging algorithm at the RAN node and is transmitted over the air via signaling protocols such as radio resource control (RRC) messaging, uplink control information (UCI), or scheduled physical uplink shared channel (PUSCH) transmissions. The model update may comprise either full model weights or delta weights relative to the version originally received by the WTRU, and may be transmitted in compressed or quantized form to reduce bandwidth consumption.

In addition to model updates, each WTRU may transmit associated metadata comprising a local training sample size, a prediction confidence or validation accuracy measure, and an indication of computational effort expended. The computational effort may be derived from metrics such as number of executed local training epochs, processing time, or device CPU usage, and may be represented as a scalar or vector. This metadata allows the RAN node to assign a corresponding weight to each WTRU's contribution during model aggregation, thereby enabling weighted averaging of model parameters based on the quality and significance of the local training performed.

Each WTRU may further transmit a model version identifier that indicates the version of the global model used as the basis for local training. This version identifier allows the RAN node to associate received updates with the correct global model version and discard stale or mismatched updates. A timestamp of the local training session may also be included in the metadata to ensure that only timely contributions are incorporated into the global model aggregation process. That is particularly useful in case WTRUs experience AI model delivery delay to the RAN node and hence, introducing a considerable delay among the moment the AI model has been actually trained versus being updated to the RAN node.

Additional metadata fields may include the device class of the WTRU, such as smartphone, IoT device, or vehicular user equipment. The RAN node may use this information to segregate updates by device class and maintain separate global model instances for each class. This enables optimization of AI/ML model performance across heterogeneous device capabilities and usage contexts. Each global model instance may maintain its own independent versioning scheme and may be updated conditionally based on the aggregated contributions within that device class.

The transmitted metadata may also include training loss values or CPU load indicators, which further assist the RAN node in filtering out low-quality updates and enforcing energy-efficient participation policies. These parameters are encapsulated in a standardized container format for delivery over the chosen uplink signaling mechanism. Upon reception, the RAN node applies a federated averaging algorithm that uses the provided metadata to compute a weighted average of received models or gradients, and updates the global model instance accordingly, contingent on the contributions meeting predefined quality thresholds.

After aggregating 1006 the received models or gradients, the RAN node increments 1007 the version identifier of the globally updated AI/ML model. The updated model is then transmitted to connected-mode WTRUs for further use or training. The RAN node schedules the next training cycle based on the network's requirements, ensuring that idle-mode WTRUs are continuously engaged in model training and contributing to the network's AI/ML performance improvements. This entire process ensures a systematic and efficient distribution of AI/ML model training across the network, balancing the need for model improvements with the participation of devices under varying operational conditions.

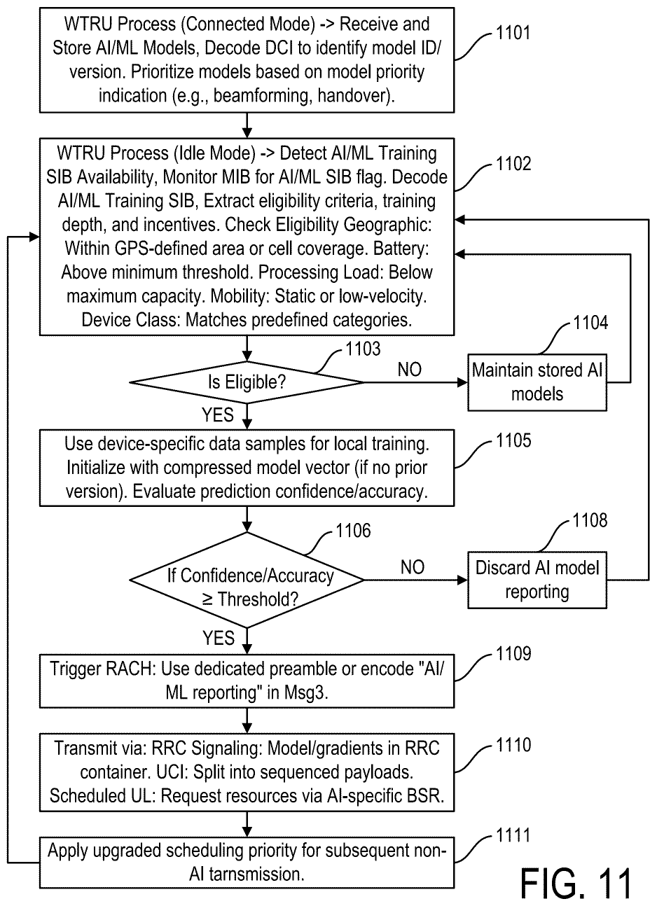

FIG. 11 shows the overall WTRU action steps where the WTRU begins by receiving 1101 one or more AI/ML models from the RAN node through either a device-specific data channel or an AI-device-group-common data channel. The models are stored locally on the WTRU, and this storage is managed in such a way that the device can access the models when transitioning into the idle mode state. Upon detection of the presence indication for AI/ML idle mode training, which is broadcast via the master information block (MIB), the WTRU processes 1102 the received AI/ML idle mode training system information block (SIB). This SIB includes critical training eligibility configurations, including the model identifiers, version identifiers, and the criteria that define which WTRUs are eligible 1103 to participate in the AI/ML model training process while in idle mode. If the WTRU is not eligible, it may maintain 1104 stored AI models.

Once the WTRU enters idle mode and has processed the SIB, it starts executing the training 1105 of the AI/ML model using local device-specific data samples. During this process, the WTRU evaluates the performance of the trained model, measuring its prediction confidence or accuracy based on the local training data. If the trained model reaches a predefined accuracy or confidence threshold 1106, the WTRU triggers a temporary random-access procedure 1107. Otherwise, if confidence/accuracy is below a threshold, AI model and reporting may be discarded 1108 or stopped.

This procedure includes a service cause indication of “AI/ML model training reporting,” signaling to the RAN node that the model is ready for reporting. The service cause is encoded in a radio resource control (RRC) connection request message or a message payload of a random-access channel (RACH) procedure 1009, prioritizing the WTRU's training report over other potential requests without requiring a full quality of service (QoS) profile establishment.

Upon triggering the random-access procedure, the WTRU transmits 1110 the trained AI/ML model or corresponding gradients to the RAN node. This transmission 1110 can occur through various channels, such as RRC signaling, uplink control information (UCI), or a scheduled uplink data channel. If the model or gradients are transmitted via UCI, the WTRU segments the data into multiple UCI payloads across consecutive uplink subframes, each with a sequence number to ensure proper reconstruction of the entire model or gradient at the RAN node. When using a scheduled uplink data channel, the WTRU dynamically requests the necessary uplink resources via a buffer status report (BSR), which is flagged with an AI/ML-specific logical channel group (LCG) identifier. This flagging ensures that the RAN node prioritizes the resource allocation for the training data over non-AI/ML traffic. The WTRU applies 1111 the scheduling priority.

After successfully transmitting the trained model or gradients, the WTRU continues to monitor the network for further AI/ML training opportunities or updates to the model. If the WTRU receives updated AI/ML models from the RAN node in subsequent communication cycles, it stores these models locally and proceeds to re-initiate or continue training, depending on the configuration and availability of new data. This iterative process ensures that the WTRU remains actively engaged in distributed AI/ML model training, constantly refining its model and contributing to the network's overall AI capabilities. By following this sequence, the WTRU effectively participates in a decentralized AI/ML training system that continuously enhances the overall performance and adaptability of the network.

A method implemented by a Radio Access Network (RAN) node for distributed AI/ML model training in a cellular network, the method comprising: Storing one or more AI/ML models, each associated with a model identifier and a version identifier; Transmitting the one or more AI/ML models to connected-mode wireless transmit/receive units (WTRUs) via at least one of a device-specific data channel or an AI-device-group-common data channel; Broadcasting, during a global AI/ML model training periodicity, a master information block (MIB) signaling indicating availability of an AI/ML idle mode training system information block (SIB); Transmitting the AI/ML idle mode training SIB, including AI/ML training eligibility configurations; Receiving, from idle-mode WTRUs, trained AI/ML models or corresponding gradients via at least one of radio resource control (RRC) signaling, uplink control information (UCI), or scheduled uplink data channels; Aggregating the received trained models or gradients to generate a globally updated AI/ML model; and incrementing the version identifier of the globally updated AI/ML model.

Transmitting the one or more AI/ML models to connected-mode WTRUs via the AI-device-group-common data channel comprises multi-casting the AI/ML models to a predefined group of WTRUs sharing a common AI/ML service identifier, wherein the AI/ML models are transmitted as group-common user-plane data within shared PRBs mapped to the AI-device-group-common data channel.

The downlink control information (DCI) accompanying the transmission of the AI/ML models includes the model identifier and version identifier in a dedicated field of the DCI formatted according to a predefined DCI format, wherein the predefined DCI format is configured to prioritize AI/ML model identifier signaling over other control information types.

The RAN node groups AI-capable wireless transmit/receive units (WTRUs) may be served by the same downlink beam into one or more AI training groups, each group assigned a group-common control search space configuration and a group-common radio network temporary identifier (RNTI), wherein the DCI is transmitted via a group-common physical downlink control channel (PDCCH) when the AI/ML models are transmitted over the AI-device-group-common data channel, and wherein the group-common PDCCH is scrambled using the group-common RNTI, enabling WTRUs in the AI training group to descramble the DCI within the assigned group-common control search space.

The RAN node configures connected-mode wireless transmit/receive units (WTRUs) with a model priority indication for each of one or more stored AI/ML models, wherein the model priority indication is transmitted via at least one of a device-specific data channel or an AI-device-group-common data channel, and wherein broadcasting the master information block (MIB) signaling during a global AI/ML model training periodicity further comprises including a model priority threshold, the model priority threshold instructing idle-mode WTRUs to activate training of all stored AI/ML models with a model priority indication equal to or higher than the model priority threshold.

Configuring connected-mode WTRUs with the model priority indication further comprises associating each model priority indication with a predefined AI/ML task category, wherein the AI/ML task category includes at least one of beamforming optimization, handover prediction, or traffic load balancing,

Transmitting the AI/ML idle mode training SIB includes configuring the AI idle mode training request indication as a 1-bit flag within the SIB, wherein the flag is set to a predefined value to signal idle-mode WTRUs to decode the remaining SIB fields containing the model identifier, version identifier, eligibility criteria, and training depth configurations.

The model identifier and version identifier of the AI/ML model to be trained during idle mode are included in a dedicated SIB field formatted to prioritize model identification, wherein the model identifier corresponds to a globally unique AI/ML service identifier registered in the cellular network.

The eligibility criteria for idle mode WTRUs include predefined geographical coordinates defining a geographic area for training participation, wherein the geographic area is specified as a set of GPS coordinates or a cell coverage area identifier, and wherein WTRUs outside the geographic area are excluded from training.

The eligibility criteria for idle mode WTRUs include a minimum battery capacity threshold, wherein the threshold is dynamically adjusted by the RAN node based on historical training participation rates or network-wide energy-saving policies.

The eligibility criteria for idle mode WTRUs include a maximum processing load threshold, wherein the threshold is defined as a percentage of the WTRU's total computational capacity, and wherein the RAN node updates the threshold periodically based on reported device capabilities.

The eligibility criteria for idle mode WTRUs further include a mobility state threshold, wherein the mobility state threshold is defined as a maximum velocity or handover frequency, and wherein WTRUs exceeding the mobility state threshold are excluded from training to prioritize contributions from static or low-mobility devices.

The eligibility criteria for idle mode WTRUs include eligible device classes, wherein the device classes are predefined categories comprising at least smartphones, IoT devices, or vehicular user equipment, and wherein the RAN node restricts training participation to WTRUs belonging to the specified classes.

Transmitting the AI/ML idle mode training SIB further comprises including a compressed model initialization vector, wherein the initialization vector is a reduced-size representation of the AI/ML model parameters generated using a quantization technique, and wherein idle-mode WTRUs use the initialization vector to initialize local training when no prior model version is stored.

The AI model training depth configurations specify that full local model training is requested for WTRUs meeting a minimum battery capacity and maximum processing load threshold, while partial gradient updates are requested for WTRUs below the battery capacity threshold or above the processing load threshold.

Aggregating the received trained models or gradients comprises applying a federated averaging algorithm to combine contributions from multiple idle-mode WTRUs, wherein the contributions are weighted based on at least one of the WTRUs' reported prediction confidence, data sample size, or computational resources utilized during training.

Incrementing the version identifier of the globally updated AI/ML model is conditional upon the aggregated trained models or gradients meeting a predefined quality metric, wherein the quality metric is derived from at least one of a validation accuracy threshold, a minimum number of contributing WTRUs, or a consensus threshold among contributions.

Aggregating the received trained models or gradients includes segregating contributions based on the WTRUs' device classes, wherein separate global models are generated for each device class, and wherein each global model is assigned a unique version identifier incremented independently.

The RAN node further transmits an incentive indicator to idle-mode wireless transmit/receive units (WTRUs) via the AI/ML idle mode training system information block (SIB), wherein the incentive indicator specifies multiple participation incentive levels, each participation incentive level corresponding to an upscaled scheduling priority level for network resource allocation offered to WTRUs that execute and report trained AI/ML models or corresponding gradients, and wherein the RAN node tracks WTRU participation to assign the corresponding scheduling priority level based on the reported AI/ML model contributions.

The RAN node further includes a participation frequency threshold in the AI/ML idle mode training SIB for each participation incentive level, wherein the participation frequency threshold specifies a minimum number of successful AI/ML model training reports required within a predefined time window to qualify for the corresponding scheduling priority level, and wherein the RAN node downgrades the scheduling priority level of a WTRU failing to meet the participation frequency threshold.

The scheduling priority level for each participation incentive level is implemented as a modified logical channel prioritization (LCP) configuration, wherein the RAN node assigns a unique LCP priority value to each participation incentive level, and wherein WTRUs apply the assigned LCP priority value to uplink transmissions carrying non-AI/ML data following successful AI/ML model training reports.

A method implemented by a wireless transmit/receive unit (WTRU) for participating in distributed AI/ML model training in a cellular network, the method comprising: receiving and storing one or more AI/ML models from a Radio Access Network (RAN) node via at least one of a device-specific data channel or an AI-device-group-common data channel; on condition of transitioning to an idle mode state, detecting a presence indication of an AI/ML idle mode training system information block (SIB) via a master information block (MIB) broadcast; and receiving the AI/ML idle mode training SIB; executing training of the AI/ML model using device-specific data samples and evaluating prediction confidence or accuracy of the trained model; triggering a temporary random-access procedure with a service cause indication of ‘AI/ML model training reporting’ when the prediction confidence or accuracy meets a predefined threshold; and transmitting the trained AI/ML model or corresponding gradients to the RAN node via at least one of RRC signaling, UCI, or a scheduled uplink data channel.

Triggering the temporary random-access procedure with the service cause indication of AI/ML model training reporting comprises encoding the service cause in a radio resource control (RRC) connection request message or a Msg3 payload of a random-access channel (RACH) procedure, wherein the service cause is mapped to a predefined value in a dedicated field of the message to prioritize the RAN node's processing of the AI/ML training reporting request without quality of service profile establishment.

Triggering the temporary random-access procedure further comprises selecting a dedicated random-access preamble reserved for AI/ML model training reporting, wherein the dedicated preamble is signaled to the WTRU in the AI/ML idle mode training SIB.

Transmitting the trained AI/ML model or corresponding gradients via RRC signaling includes encapsulating the model or gradients in an RRC container message, wherein the container message is formatted to include metadata comprising the model identifier, version identifier, and timestamp of the local training session.

Transmitting the trained AI/ML model or corresponding gradients via uplink control information (UCI) comprises segmenting the model or gradients into multiple UCI payloads transmitted over consecutive uplink subframes, wherein each UCI payload includes a sequence number to enable the RAN node to reconstruct the complete model or gradients.

Transmitting the trained AI/ML model or corresponding gradients via a scheduled uplink data channel includes dynamically requesting uplink resources through a buffer status report (BSR) flagged with an AI/ML-specific logical channel group (LCG) identifier, wherein the RAN node prioritizes resource allocation for the flagged BSR over non-AI/ML traffic.

In modern wireless communication systems, Radio Access Network (RAN) nodes are tasked with continuously supporting uplink access procedures for a diverse set of Wireless Transmit/Receive Units (WTRUs). Maintaining all receiver chains in an active state imposes a significant energy burden, particularly as network densification and advanced antenna technologies (e.g., massive MIMO) drive up the number of beams and monitoring requirements. To mitigate power consumption, RAN nodes commonly employ Discontinuous Reception (DRX), whereby receiver circuits enter low-power “OFF” states during predefined intervals. Through DRX, base stations can realize substantial energy savings by deactivating portions of the radio front-end when traffic demand is low.

Conventional DRX presents a shortcoming: during DRX OFF periods, the RAN node shuts down all reception paths, effectively preventing the timely detection of random-access requests. Such requests may be unpredictably generated, not only for routine service establishment (e.g., handover, throughput ramp-up) but also for urgent emergency triggers (e.g., 911 calls, medical or fire alarms). Regulatory requirements mandate that WTRUs must be able to initiate uplink random access at any time to support life-critical services. A complete shutdown of receivers thus conflicts fundamentally with the need for guaranteed emergency access. Accordingly, there is a pressing need for adaptive DRX solutions that reconcile energy-efficient operation with uninterrupted support for random access triggers.

US Patent Publication no. 20210266057 to Asplund et al. titled “Beamforming for Random Access Channel (RACH)” is incorporated by reference herein in its entirety. Asplund focuses on beamforming techniques for RACH procedures and describes methods by which a network node performs beamforming to facilitate the random access process, aiming to improve the efficiency and reliability of initial access in wireless communication systems.

US Patent Publication no. 20230116354 to Abedini et al. titled “Two-step random access channel procedure” is incorporated by reference herein in its entirety. Abedini introduces a two-step RACH procedure aimed at reducing latency and improving efficiency in random access processes. It outlines configurations for RACH occasions and parameters for transmitting and receiving random access messages.

The adaptive DRX OFF solution maintains a minimal set of active beams during DRX OFF periods to ensure that both emergency and high-priority non-emergency service triggers are always received, such that life-critical calls (e.g., 911) can access the network over a reduced number of beams at any time and predefined high-QoS events, such as robotic control updates or industrial alarms, are treated with the same priority and never impaired by power-saving measures.

Thus, in one embodiment, the RAN node continuously monitors uplink random-access traffic on each beam group and computes, at configurable intervals, a congestion score using a weighted sum of active WTRU counts, RACH attempts, and collision rates, normalizing the result to a predefined scale; when the score for a given beam group exceeds a preset Congestion Increase Threshold relative to its previous score, the RAN node allocates an additional time-frequency RACH occasion to that beam group and updates its internal mapping tables to reflect the new resource availability.

A RAN node may not have a precise geolocation and density of idle mode devices. For one beam group, a single random access occasion may be sufficient because there are not many devices around all beams of this beam group. For another beam group of many devices in proximity and a single RACH occasion, collision/congestion may increase because many devices are competing on the same RACH occasion and that may trigger the RAN node to (immediately) allocate additional RACH occasions for this beam group as long as the rate of congestion on the beam group keeps increasing.

For example, assuming there is an emergency in a school or a hospital and many are calling emergency services and/or families suddenly all at once while the RAN has already decided reduced RACH capability (likely during class time with a low connection establishment time), and so, in a couple of seconds (which may be a lot of time to RAN), it may allocate more and more RACH occasions to this group until it almost falls back to conventional way (one RACH occasion per each beam).

In an embodiment, the RAN node assigns service-specific tags to certain RACH occasions by marking them with emergency or critical sensing labels, reserves a configurable percentage of occasions for general access, and broadcasts an updated Beam Resource Mapping Table (BRMT) during each DRX ON period via system information blocks, including per-beam congestion scores, general and tagged RACH occasion pools, and beam group mappings, thereby enabling WTRUs to make informed access decisions.

In a further embodiment, the RAN node dynamically merges or splits beam groups in response to sustained high allocation frequencies-when the number of added occasions in a beam group reaches a Reconfiguration Trigger Limit- and redistributes RACH occasions from low-congestion groups to those approaching threshold levels, all while enforcing a minimum resource constraint to guarantee at least one access occasion per group.

In one embodiment directed to the WTRU, upon detecting an event with emergency priority, the device retrieves the latest BRMT during its next DRX ON interval, measures the RSRP of available downlink beams, filters to those above a configurable Min RSRP Threshold, and selects the beam group with the lowest congestion score; it then chooses a tagged RACH occasion if available for the specific service type or falls back to a general occasion, constructs the preamble using the best beam's precoding vector, and transmits the emergency access request during the DRX OFF period.

In another WTRU-centric embodiment, the device ranks all beams by recent RSRP measurements, scans only the top N beams that exceed an RSRP Quality Offset to conserve its own receiver energy, and if its first preamble transmission fails, automatically retries on the next-best beam group's selected RACH occasion, up to a configurable Failure Count Threshold before reverting to general access or alerting the user.

In an embodiment combining both node and device actions, the RAN node shortens its congestion-monitoring interval when the emergency random-access detection rate surpasses a predefined percentage, thereby providing more frequent BRMT updates, while WTRUs adapt by increasing their DRX ON frequency under high-priority conditions, ensuring that both sides synchronize more closely to maintain ultra-reliable emergency access without unduly compromising energy savings.

The radio access in a Radio Access Network (RAN) node continuously collects real-time metrics for each defined random-access beam group, including the current count of active Wireless Transmit/Receive Units (WTRUs) associated with a group, the number of Random-Access Channel (RACH) attempts observed during a most recent monitoring window, and the collision rate determined by the proportion of preamble failures due to overlapping transmissions. The RAN node may apply three configurable weighting factors—W₁ for active WTRU count, W₂ for RACH attempts, and W₃ for collision rate, where W₁+W₂+W₃=1—to compute a composite congestion value, and then normalizes that value to a predefined scale (for example, 0-100 or a logarithmic range) to yield a congestion score. This score is updated at each congestion monitoring interval, which may itself be adaptive based on network conditions, and is stored in the node's internal resource management database for subsequent decision logic, enabling dynamic allocation or deallocation of RACH occasions, service-specific tagging, and broadcast of an up-to-date Beam Resource Mapping Table to WTRUs.

The RAN node further supports emergency radio access by tagging select Random Access Channel (RACH) occasions with emergency service type indications, wherein each tagged occasion is associated with a predefined service-cause indicator corresponding to an emergency trigger such as a public safety call, fire alarm, or medical distress signal; upon computing per-beam congestion scores and adjusting RACH occasion allocations, the RAN node reserves a subset of occasions specifically for emergency access, includes the service-cause indicator in the broadcast Beam Resource Mapping Table, and dynamically updates these reservations in response to shifts in emergency traffic patterns to guarantee that any WTRU initiating an emergency random-access request can be served immediately even during DRX OFF periods.

In one embodiment, the Radio Access Network (RAN) node supports prioritized emergency access by tagging selected Random Access Channel (RACH) occasions with emergency service type indications. Each tagged occasion is associated with a predefined service cause indicator, which corresponds to a specific emergency trigger such as a public safety call, fire alarm, or medical distress signal. These indicators are configured based on operator-defined policies and may be represented in coded form or as semantic identifiers that distinguish between types of emergency services. The tagging process ensures that certain RACH occasions are dedicated exclusively to emergency-initiated random-access procedures, thereby reducing contention and access delay for Wireless Transmit/Receive Units (WTRUs) in critical scenarios.

The RAN node further includes the tagged RACH occasion information in the Beam Resource Mapping Table (BRMT), which is broadcast to all WTRUs at a configurable interval during active Discontinuous Reception (DRX) periods. The BRMT includes not only the beam group identifiers and associated congestion scores, but also the mapping of service-specific RACH occasions and their corresponding service cause indicators. As a result, WTRUs are equipped with updated knowledge of which RACH occasions are allocated for specific emergency services, enabling them to make informed decisions when initiating random access during DRX OFF periods.

Upon the occurrence of an emergency condition, a WTRU evaluates the BRMT received during the last DRX ON period and identifies the beam group and RACH occasion tagged for its specific service type. By matching its own service cause to the tagged entry in the BRMT, the WTRU can select and transmit an emergency preamble over the correct access opportunity. This behavior enhances the reliability and timeliness of emergency access under power-saving receiver configurations, aligning with both regulatory mandates and system-level energy efficiency goals.

In another embodiment, the RAN node distinguishes higher-priority non-emergency service triggers by marking certain RACH occasions with non-emergency service type indications that carry predefined service-cause indicators for events such as industrial control updates, infrastructure monitoring alarms, or time-sensitive telemetry, and associates these occasions with designated beam groups; the node broadcasts these mappings alongside congestion scores in the Beam Resource Mapping Table and dynamically allocates or deallocates the tagged occasions based on real-time network load, thereby ensuring that WTRUs generating high-priority non-emergency access requests receive expedited uplink opportunities without compromising the availability of less time-sensitive random-access resources. Other RACH occasions may be used for low latency traffic and thus those may not be tagged.

Specifically, the RAN node computes a congestion score for each random-access beam group by first gathering three key performance indicators—the current number of active WTRUs associated with the beam group, the total count of RACH attempts observed within a predefined monitoring window, and the collision rate determined from the ratio of failed RACH attempts due to preamble overlap—and then applying a respective set of configurable weighting factors to each indicator. The sum of these weighted indicators is normalized to a predefined scale, such as a linear range or logarithmic band, to yield a dimensionless congestion score, and this score is recalculated and updated at each configurable congestion monitoring interval so that the RAN node's resource allocation logic always reflects prevailing network conditions. US Patent Publication no. 20230262688 to Kiilerich Pratas et al. is incorporated by reference herein. Kiilerich Pratas describes methods for reducing the RACH collision rate and such methods may be incorporated with the embodiments described herein.

In another embodiment, the RAN node enhances its congestion-scoring procedure by dynamically adjusting the configurable weights in response to a predefined network load metric: when the total RACH attempts exceed a configurable activity threshold, the weight applied to the RACH-attempt indicator is increased by a predetermined offset relative to the weight for active WTRUs, thereby sharpening sensitivity to access demand; the resulting composite value is then normalized to a predefined logarithmic scale to emphasize rapid fluctuations in congestion. Furthermore, the congestion monitoring interval itself is adaptively shortened by a preset duration step whenever the emergency random-access detection rate surpasses a predefined threshold, ensuring that critical access events trigger more frequent score updates and correspondingly prompt resource reconfiguration.

In an embodiment, a higher-layer core network entity—such as an Operations, Administration, and Maintenance (OAM) server or Self-Organizing Network (SON) function—provisions the configurable weighting factors to the RAN node via secure backhaul signaling; these weight parameter definitions, including values for active-WTRU count, RACH attempt count, and collision rate coefficients, are delivered over the S1 or X2 interface and subsequently encapsulated by the RAN node into one or more downlink system information blocks (SIBs) or individualized radio resource control (RRC) update messages, thereby enabling network operators to remotely tune the congestion-scoring algorithm without manual intervention at the base station.

In another embodiment, once the RAN node has computed and normalized the congestion score for each beam group, it embeds the score along with a precise timestamp in a dedicated field of the Beam Resource Mapping Table (BRMT); the BRMT—comprising beam group identifiers, RACH occasion pools, service-type tags, congestion scores, and corresponding timestamps—is broadcast to all WTRUs during DRX ON periods via a designated SIB or included within downlink control information (DCI) messages, ensuring that each device receives up-to-date congestion metrics and timing context to inform its random-access selection logic.

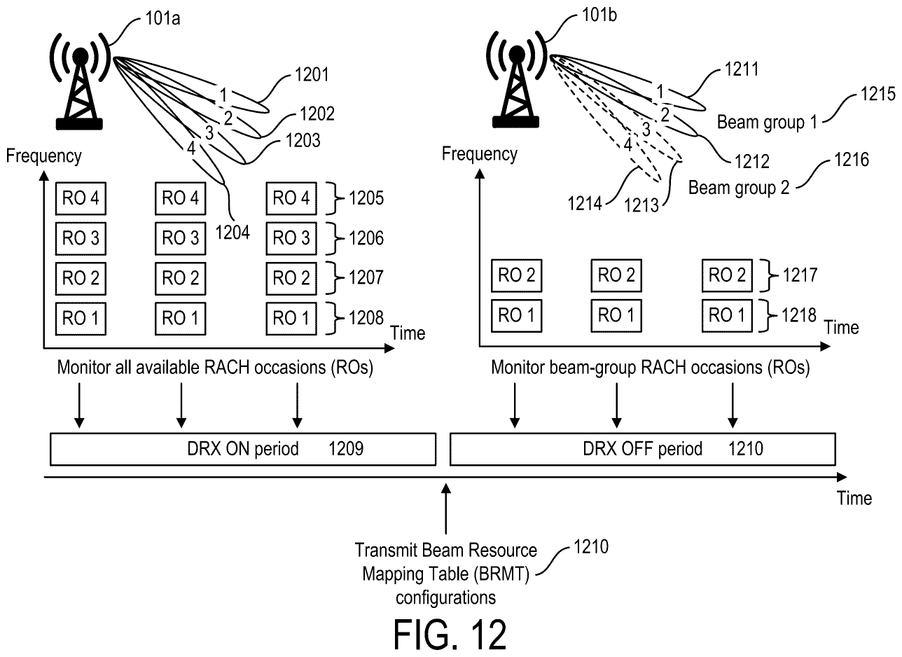

FIG. 12 demonstrates an embodiment wherein the RAN node 101a, 101b evaluates a current congestion score for each random-access beam group against its immediately preceding score and, upon detecting a change that exceeds a predefined Congestion Increase Threshold, dynamically allocates an additional time-frequency RACH occasion to the affected beam group; conversely, if the score falls below a predefined Congestion Decrease Offset, the RAN node deallocates an existing occasion—subject to a configurable minimum resource constraint—to optimize spectral efficiency. The thresholds and offsets that govern these adjustments are defined in the operator's policy configuration and may be updated via higher-layer signaling, ensuring that the RAN node's random-access resources scale in real time with network demand while avoiding unnecessary oscillations in occasion assignments. In embodiments, RAN nodes may coordinate such that for critical devices, they select the uplink resources of the lowest interference coming from nearby nodes.

FIG. 12 shows a RAN node (first time period) 101a that monitors ROs on four different beams (beam 1 1201, beam 2 1202, beam 3 1203, beam 4 1204) each associated with a different frequency during a DRX ON period 1209. From low to high frequency, ROs may be dedicated in the order of RO1 1205, RO2 1206, RO3 1207 and RO4 1208. The BRMT 1210 may be transmitted next.

During a DRX OFF period 1210, a RAN node (second time period) 101b, configures beams 1 1211 and 2 1212 to a first beam group 1215 and beams 3 1213 and 4 1214 are configured to a second beam group 1216. The RAN node (second time period) 101b may monitor beam group RACH occasions. For instance, RAN node (second time period) 101b monitors RO1 1218 and RO2 1217 associated with beam group 1 1215 and beam group 2 1216 respectively.

In another embodiment directed to high-density deployments, the RAN node not only apply the Congestion Increase Threshold for occasion allocation but also prioritizes the assignment of additional RACH resources to beam groups serving elevated user concentrations: upon determining that a beam group's congestion score has surpassed its previous value by the requisite threshold, the node references a predefined density metric—calculated from metrics such as average WTRU spatial distribution or instantaneous attachment counts—and preferentially allocates extra time-frequency RACH occasions to those beam groups exhibiting the highest device densities. This density-aware prioritization ensures that densely populated areas receive the greatest augmentation of access opportunities, thereby maintaining low access latency and high reliability in the most heavily loaded sectors of the cell.

Further, the RAN node tracks the number of additional time-frequency RACH occasions allocated to each beam group over a rolling observation window and, when this allocation count for any given group exceeds a configurable Reconfiguration Trigger Limit, the node initiates a beam group reconfiguration procedure to restore balance in random-access resource distribution; specifically, the procedure evaluates adjacent or overlapping beam groups and, based on factors such as inter-group interference, user density, and spatial coverage overlap, either merges the over-provisioned group with a neighboring group to consolidate RACH occasions or splits the group into two or more narrower beam groups to more finely distribute access opportunities. This reconfiguration is performed seamlessly by updating the beam-to-RACH-occasion mappings in the Beam Resource Mapping Table and broadcasting the revised configuration during the next DRX ON interval, thereby ensuring that RACH resources remain proportionally allocated across all beam groups in response to sustained demand patterns without manual intervention.

Therefore the RAN node continuously compares the current congestion score for each beam group against its immediately preceding value and, when the score decreases by at least a predefined Congestion Decrease Offset, deallocates one or more time-frequency RACH occasions from the corresponding beam group; however, to guarantee baseline emergency access availability, the node enforces a configurable minimum resource constraint such that each beam group retains at least a predetermined number of RACH occasions, ensuring that even under light load conditions a WTRU can always access the network for urgent or emergency triggers.

RAN node further incorporates a resource reallocation minimum delay when deallocating RACH occasions, such that once an occasion is removed from a beam group, a predefined waiting period may be required to elapse before any further deallocation or reallocation can occur, e.g. using a timer; this delay prevents rapid oscillations of RACH occasion assignments in response to transient fluctuations in congestion, while the minimum resource constraint ensures that at least one RACH occasion remains available per beam group unless the traffic load falls below a predefined Low Activity Threshold that permits temporary suspension of all non-emergency access resources.

When deallocating RACH occasions in response to a congestion drop, the RAN node identifies other active beam groups whose current congestion scores lie within a specified offset below their respective Congestion Increase Thresholds and redistributes the deallocated occasions to those groups; by proactively reallocating resources to beam groups on the verge of increased demand, the node maintains a balanced and anticipatory RACH provisioning across the network, improving access responsiveness without violating the minimum resource constraint for any group.

The RAN node may further implement service-aware random-access by first retrieving operator-defined policy parameters that specify service type categories—such as “medical emergency,” “fire,” or “critical sensing update”—and then mapping these categories to individual RACH occasions within each beam group; for each occasion, the node embeds a service-type indicator in its internal scheduling table and reserves a configurable percentage of the total RACH occasions in the group exclusively for general or default service triggers, ensuring that untagged or lower-priority access attempts can still proceed even when service-specific pools are occupied. Once the tagging and reservation configuration is finalized, the node incorporates the service-type associations and the percentage allocations into the Beam Resource Mapping Table, which is broadcast to WTRUs during DRX ON periods, thereby enabling devices to select the appropriate RACH occasion based on their triggered service type while guaranteeing baseline access opportunities for all other services.

In one embodiment, the RAN node may implement a resource allocation scheme to manage RACH occasion assignments across different service categories. Operator-defined service categories, such as “medical emergency,” “fire,” “critical sensing update,” and “default/general access,” are grouped into logical service buckets, each corresponding to a predefined priority class. The RAN node allocates a configurable percentage of RACH occasions within each beam group to each bucket based on historical service demand, regulatory mandates, or network configuration profiles. For instance, a fixed minimum percentage of RACH occasions may always be reserved for the lowest-priority bucket to ensure that even non-critical service triggers retain baseline access opportunities, preventing starvation in heavily loaded conditions.

Further, to enforce dynamic fairness, the RAN node monitors per-bucket access demand and success/failure statistics over a configurable observation window. If a high-priority bucket experiences surges in emergency traffic, exceeding a preconfigured threshold, the RAN node may temporarily expand its allocation by borrowing underutilized occasions from adjacent lower-priority buckets, subject to a predefined upper limit per service class. Conversely, if the lower-priority buckets are nearing exhaustion and higher-priority buckets are operating below threshold utilization, surplus RACH occasions may be temporarily reassigned to maintain access viability for general services. This conditional redistribution is tracked using time-stamped access logs to ensure that borrowed resources are periodically rebalanced back to their original buckets.

In an additional option, the RAN node may broadcast a service access sharing indicator in the Beam Resource Mapping Table (BRMT), which notifies WTRUs of any temporary cross-bucket sharing status. This enables WTRUs to determine whether fallback to a non-tagged RACH occasion is permitted when their service-specific pool is fully occupied. In doing so, the system enables flexible access arbitration that guarantees minimum resource availability for all service classes without rigid over-provisioning. The bucketed allocation and adaptive resource elasticity ensure fairness and continuity of service for lower-priority or background traffic, while still maintaining preferential treatment for mission-critical emergency or industrial triggers.

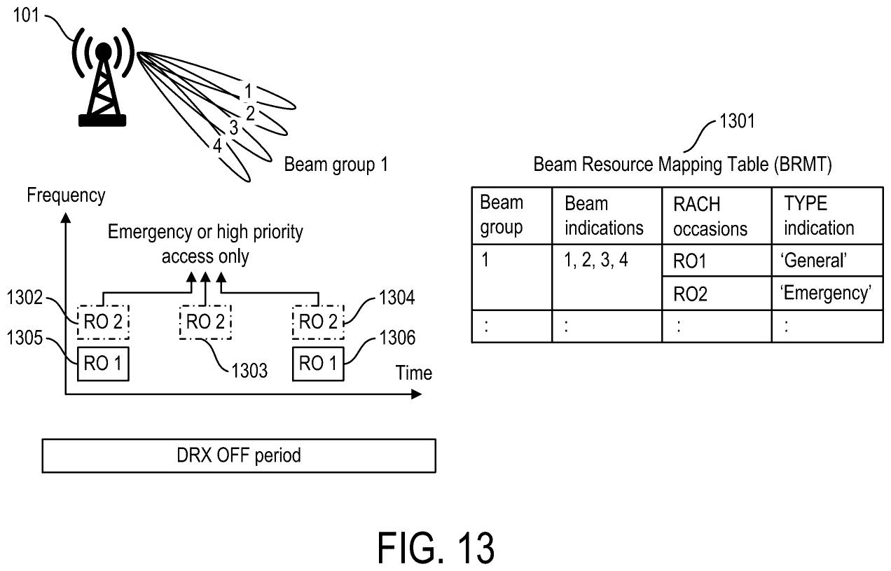

As shown by FIG. 13, the RAN node 101 periodically broadcasts a Beam Resource Mapping Table (BRMT) 1301 during active Discontinuous Reception (DRX) ON periods at a configurable time periodicity, wherein the BRMT 1301 comprises a comprehensive listing of each random-access beam group's identifier, its current normalized congestion score, the set of general RACH occasions 1305, 1306, and any service-specific RACH occasion pools, e.g. including ROs 1302-1304, tagged for emergency or high-priority non-emergency triggers. The BRMT is transmitted as part of device-common downlink control channel information (DCI) messages or embedded within one or more system information blocks (SIBs), with the periodicity parameterized by the network operator to balance signaling overhead against the need for up-to-date access information; by receiving the BRMT at each DRX ON interval, WTRUs obtain synchronized visibility into available access resources and congestion metrics, enabling informed selection of beam groups and RACH occasions even during subsequent DRX OFF periods. In embodiments, the BRMT or information pertaining to the BRMT may be provided via SIB, with other information provided via DCI.

In addition to periodic broadcast transmission of the Beam Resource Mapping Table (BRMT) during active DRX ON periods, the RAN node may support on-demand BRMT retrieval functionality. This capability is particularly advantageous for low-complexity or memory-constrained WTRUs, which may be incapable of persistently decoding or storing the full contents of the system information blocks (SIBs) that contain the BRMT. In such cases, rather than requiring the device to continuously parse large broadcast messages, the RAN node allows the WTRU to request a dedicated scheduling of the BRMT information on demand.

To support this mechanism, the RAN node allocates a dedicated RACH occasion or a default random-access opportunity—distinct from service-specific tagged pools—specifically for the purpose of BRMT request signaling. A WTRU that detects the need for updated access information during a DRX OFF period, or one that is entering network coverage without stored BRMT context, may transmit a lightweight request using this default RACH occasion. Upon successful decoding, the RAN node responds by scheduling a short, targeted downlink message, such as a Device Specific Control Information (DSCI) or unicast message, containing the latest BRMT or a subset thereof tailored to the WTRU's service category or beam group.

The RAN node may also indicate the availability of BRMT on-demand support via a broadcast capability flag in an existing system or master information message. This informs WTRUs whether default RACH occasions are configured to accept BRMT requests and enables compatible devices to dynamically choose between relying on periodic broadcasts or requesting updated BRMT data as needed. The hybrid approach ensures both high accessibility for devices requiring full visibility and low-complexity fallback paths for constrained or power-limited devices, while preserving robust access scheduling for critical emergency and high-priority service triggers.

In embodiments, when devices, e.g. very low capable devices whose buffers can not store all of the SIB contents including the BRMT, may request an on-demand scheduling of BRMT information only. The RAN may need to offer a default random access occasion for devices to send such on demand request.

Furthermore, the RAN node augments its Beam Resource Mapping Table (BRMT) with a fallback RACH occasion pool comprising a predefined set of untagged RACH occasions that are universally accessible by any WTRU regardless of its service type or beam-group association; this fallback pool is included in the BRMT broadcast only when the current congestion score for a given beam group exceeds a configurable Critical Congestion Threshold, thereby providing an emergency overflow mechanism that automatically opens a shared access channel under extreme load while preserving the isolation of service-specific and general RACH occasions during normal operation.

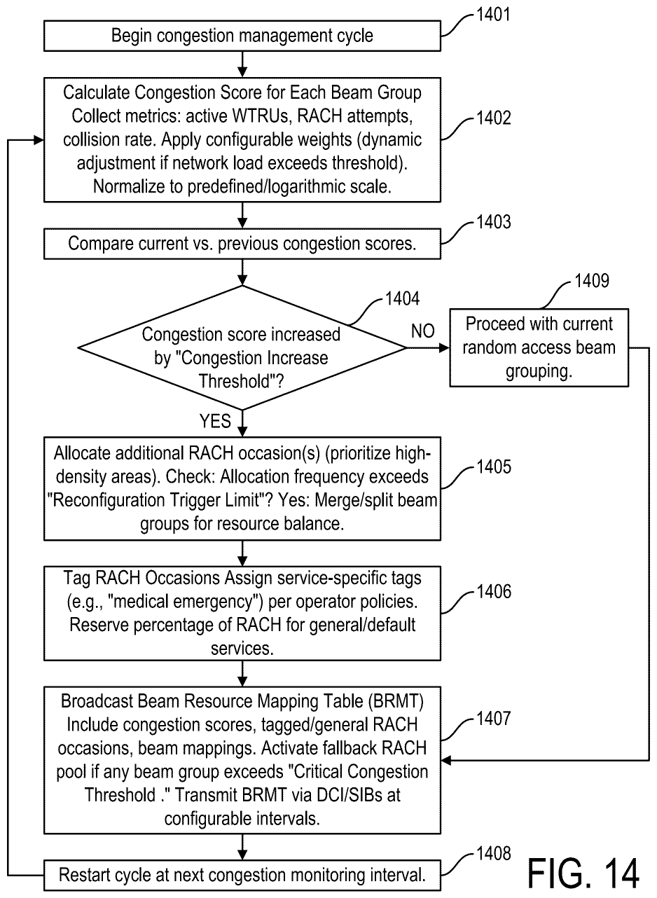

FIG. 14 illustrates a flowchart of the sequential operations performed by the RAN node to manage emergency and high-priority random access under adaptive DRX. Upon initiation 1401, the RAN node enters a periodic monitoring loop in which it gathers real-time metrics 1402 for each random-access beam group, including active WTRU counts, RACH attempt counts, and collision rates; these metrics are processed using configurable weights to compute a normalized congestion score, which is stored and timestamped.

The node then compares 1403 each group's current congestion score against its previous value: if the increase exceeds 1404 a predefined Congestion Increase Threshold, the node allocates 1405 an additional RACH occasion and, if allocation frequency passes a Reconfiguration Trigger Limit, triggers a beam-group merge or split; if the score drops below a Congestion Decrease Offset, the node deallocates an occasion after respecting a minimum resource constraint and reallocation delay, possibly redistributing deallocated occasions to other beam groups nearing their own thresholds. Next, the node applies service-type tagging 1406 by marking select RACH occasions for emergency or high-QoS non-emergency triggers and reserving a configurable percentage of occasions for general access. At each DRX ON interval, the node assembles and broadcasts 1407 an updated Beam Resource Mapping Table—including beam-group identifiers, normalized congestion scores, general, service-specific, and fallback RACH pools—via system information blocks or downlink control channel messages. Then, the node repeats 1408 the monitoring loop to ensure continuous adaptation to network demand and emergency access requirements. If the congestion score does not increase the congestion increase threshold, the current random access beam grouping may be proceeded with 1409.

On the WTRU side, a method for performing emergency radio access by a Wireless Transmit/Receive Unit (WTRU) during Discontinuous Reception (DRX) OFF periods begins with the WTRU receiving the most recent Beam Resource Mapping Table (BRMT) during a prior DRX ON period, wherein the BRMT includes updated information on beam group identifiers, associated congestion scores, and available RACH occasions, including those tagged for emergency services.

During a DRX OFF period, upon detection of an event classified as an emergency trigger, the WTRU initiates a beam selection process by measuring the received coverage levels—e.g., Reference Signal Received Power (RSRP) or Reference Signal Received Quality (RSRQ)—of candidate downlink beams across multiple beam groups. The WTRU may filter the beam groups by retaining only those in which the strongest beam has a received coverage level exceeding a configurable minimum threshold, thereby ensuring link reliability for the emergency access attempt. These eligible beam groups are subsequently ranked for further selection based on additional criteria, such as current congestion scores, RACH occasion availability, or service-specific tagging, enabling the WTRU to proceed with initiating an uplink random-access preamble over a beam group that satisfies both coverage and emergency accessibility requirements.

After selecting a set of eligible beam groups during a DRX OFF period, the WTRU proceeds to determine which Random Access Channel (RACH) occasion to use based on the service trigger that initiated the emergency access. The WTRU first references the latest Beam Resource Mapping Table (BRMT), previously received during a DRX ON period, to identify any RACH occasions tagged for its specific emergency service type-such as “emergency,” “fire,” or “critical sensing update.”

The WTRU compares its service trigger type to the service tags provided in the BRMT and selects a matching tagged RACH occasion from within the associated beam group. However, the WTRU also evaluates the current congestion score of the beam group to ensure it does not exceed a predefined Service Priority Congestion Limit. If the congestion score for the matching beam group remains within acceptable limits, the WTRU prioritizes and attempts access through the tagged occasion. If the congestion score exceeds the Service Priority Congestion Limit, indicating a high risk of collision or delay, the WTRU dynamically falls back to using a general RACH occasion from the same beam group, thereby balancing the urgency of the service request with network conditions to ensure both access reliability and congestion avoidance.

The WTRU continuously monitors the success or failure of its emergency random access attempts when utilizing a tagged RACH occasion associated with a selected beam group. If the WTRU initially selects a tagged RACH occasion based on a matching service type—such as “emergency,” “fire,” or “critical sensing update”—and attempts transmission using that occasion, it awaits a corresponding response from the RAN node within a predefined time window. Upon experiencing a failed preamble transmission, which may be determined by the absence of a response or the detection of a preamble collision, the WTRU maintains a counter to track consecutive failures. In embodiments, a predefined time window may be a configurable parameter, configured or received by a RAN node. For instance, if the RAN node is an NTN node, with much larger propagation delays, such parameter may need to be adjusted accordingly. A predefined time window may be configured in terms of number of frames, e.g. couple of seconds in examples.

When the number of failed attempts over the same tagged RACH occasion reaches a predefined Failure Count Threshold, the WTRU triggers a fallback mechanism, whereby it selects a general RACH occasion from the general pool associated with the same beam group, if available. This fallback mechanism ensures that even under conditions of tagged resource congestion or persistent interference, emergency access can still be achieved in a timely and reliable manner by reverting to more broadly accessible RACH resources, thereby enhancing robustness and service continuity during critical events.

In embodiments, devices may transmit on an emergency RACH and also transmit on the general pool, e.g. sequentially in time (one or the other first). Alternatively or in combination, they may also transmit at the same time. For example, a RAN may receive a preamble on a general pool, if “that sharing or fallback” is not allowed, it may only use the preambles assigned to general services to determine the correlation between what is received and what could be potentially transmitted (e.g. those are 20 preambles) but if fallback is allowed by the RAN node, it may also need to include additional say 20 more preambles for emergency services for determining this correlation knowing that despite, it is received over general pool, but may be it is still transmitted by a frustrated or high priority emergency user.

Upon detecting a service trigger that necessitates initiating a random-access procedure during a DRX OFF period, the WTRU utilizes the most recently received Beam Resource Mapping Table (BRMT) to evaluate the current network conditions across available beam groups. The BRMT includes normalized congestion scores for each beam group, enabling the WTRU to compare them and identify the group with the lowest congestion score among those with sufficient signal quality.

Once the optimal beam group is selected based on this congestion evaluation, the WTRU activates the corresponding random-access configuration and proceeds to select a suitable Random Access Channel (RACH) occasion within that group. If the trigger is for a general service type, the WTRU selects a RACH occasion from the general occasion pool associated with the activated beam group. Conversely, if the trigger is service-specific—such as a medical emergency or a critical sensing update—the WTRU attempts to select a RACH occasion from the tagged pool that matches the identified service type. This intelligent, congestion-aware selection process ensures that the WTRU maximizes its likelihood of successful access while aligning with service priority and current network conditions.

After selecting a random-access beam group based on minimum congestion and sufficient signal strength, the WTRU prepares to transmit an emergency random-access preamble during a DRX OFF period by determining a suitable precoding vector to maximize the likelihood of detection. The WTRU evaluates the received signal strength of each beam within the selected beam group and identifies the best serving beam, defined as the beam with the highest received coverage level, such as the maximum Reference Signal Received Power (RSRP). The WTRU then adopts the precoding vector corresponding to this best serving beam for the preamble transmission, aligning the uplink directionality with the most favorable downlink reception conditions.

On the network side, the RAN node is configured to perform blind decoding across all potential receive beams within the identified beam group, ensuring that even if the WTRU-selected precoding vector does not perfectly align with the RAN's instantaneous reception direction, the transmitted emergency preamble can still be reliably detected and decoded. This mechanism enables robust emergency access with minimal uplink delay, even in DRX OFF conditions, by leveraging adaptive beam-aligned transmission strategies without requiring the WTRU to maintain continuous uplink channel state feedback.

In one embodiment, when transmitting an emergency random-access preamble using the precoding vector of the best serving beam within the selected random-access beam group, the WTRU enhances the reliability and speed of uplink detection by embedding a beam identifier within the preamble transmission. This beam identifier explicitly indicates which downlink beam within the selected beam group was determined by the WTRU to have the highest received coverage level, thereby informing the RAN node of the most likely receive direction for successful decoding.

Upon reception, the RAN node uses the included beam identifier to prioritize receive beamforming resources and narrow the search space during blind decoding, focusing its decoding effort initially on the specified beam. This prioritization reduces processing latency and increases the probability of prompt random-access response, particularly during emergency conditions when low-latency access is critical. By combining adaptive precoding with explicit beam identification, the method improves synchronization between uplink transmission and network reception in multi-beam deployments, especially in scenarios where DRX OFF constraints would otherwise delay emergency access responsiveness.

The WTRU transmits an emergency random-access preamble during a DRX OFF period by generating a beam-group-specific precoding vector that represents a composite of all beams within the selected random-access beam group. Rather than selecting a single best-serving beam, the WTRU calculates a weighted average of the precoding vectors corresponding to each beam in the group, where the weighting factors are derived from the individual received coverage level measurements—such as RSRP or SINR—of the respective beams. The same approaches may apply to satellite and terrestrial network nodes.

This approach ensures that the resulting precoding vector reflects a spatial alignment that captures the dominant energy distribution across the beam group, improving transmission robustness in environments with fluctuating coverage or mobility. On the network side, the RAN node is configured to apply a corresponding single receive beam decoding vector that matches the structure of the WTRU's averaged precoding vector, allowing it to decode the preamble without requiring full per-beam blind decoding. This method reduces processing complexity at the RAN while enabling the WTRU to achieve reliable uplink access even under uncertainty in beam dominance, particularly during emergency-triggered transmissions where prompt and dependable access is essential.

When the WTRU transmits an emergency preamble using the precoding vector of the best serving beam—identified based on the highest received coverage level within the selected random-access beam group—the WTRU further enhances the reliability of uplink detection by applying a configurable Power Boost Factor or service-specific transmission power offset. This transmission power adjustment is conditionally applied for RACH occasions that are tagged in the Beam Resource Mapping Table (BRMT) as being associated with high-priority service types, such as “medical emergency” or “critical alarm.”

The BRMT provides not only the service tags but also the associated power configuration parameters, which the WTRU retrieves and applies to increase its preamble transmission power above the default level. This ensures that critical emergency requests transmitted during DRX OFF periods can overcome potential radio link impairments or high-noise environments. On the network side, the RAN node interprets the received signal with awareness of these power offsets, ensuring that link budget assumptions align with emergency-level transmission profiles. This dynamic power adjustment strategy enhances the probability of rapid detection and acknowledgment of emergency access attempts, further improving access reliability under life-critical scenarios.

A system for managing radio access in a Radio Access Network (RAN) node, comprising: circuitry configured to calculate a congestion score for each random-access beam group based on a weighted combination of the number of active Wireless Transmit/Receive Units (WTRUs), Random Access Channel (RACH) attempts, and collision rate; circuitry configured to adjust the number of RACH occasions for a random-access beam group based on a comparison of the group congestion score to a previous congestion score using predefined threshold and offset definitions; circuitry configured to tag specific RACH occasions with one or more service type indications and associate them with designated beam groups; a transmitter configured to broadcast a Beam Resource Mapping Table (BRMT) at a configurable interval during active Discontinuous Reception (DRX) periods, the BRMT including congestion scores, general and service-specific RACH occasions, and beam group mappings.

The RAN node may be a satellite or a terrestrial base station.

The radio access may comprise emergency radio access, and wherein the service type indications comprise emergency service type indications including predefined “service cause indicators” associated with emergency triggers.

The service type indications comprise non emergency service type indications including predefined “service cause indicators” associated with higher priority access triggers, such as industrial updates or alarm triggers.

The calculating of the congestion score involves applying configurable weights to the number of active WTRUs, the count of RACH attempts over a predefined monitoring window, and the collision rate derived from the ratio of failed RACH attempts due to preamble overlap, normalizing the result to a predefined scale, and updating the score at a configurable congestion monitoring interval to reflect real-time network conditions.

Calculating the congestion score further comprises dynamically adjusting the configurable weights based on a predefined network load metric, such that the weight for RACH attempts increases, by a predefined offset, relative to the number of active WTRUs when the total RACH attempts exceed a configurable activity threshold, normalizing the score to a predefined logarithmic scale to emphasize rapid changes in congestion, and updating the congestion score at a congestion monitoring interval that shortens, by a preset duration step, when a predefined emergency random-access detection rate is exceeded.

The configurable weights are provisioned to the RAN node by a higher-layer core network entity via backhaul signaling, the signaling comprising weight parameter definitions transmitted further by the RAN node in one or more system information blocks (SIBs) or radio resource control (RRC) messages.

The normalized congestion score and a timestamp are included in a field of the Beam Resource Mapping Table (BRMT), the BRMT being broadcast to WTRUs in a designated system information block or downlink control information (DCI) message.

Dynamically adjusting the number of RACH occasions includes allocating an additional time-frequency RACH occasion to a beam group when the congestion score exceeds the previous score by a predefined Congestion Increase Threshold, and further includes prioritizing the allocation of additional occasions to beam groups serving high-density WTRU populations based on a predefined density metric.

Allocating an additional time-frequency RACH occasion to a beam group further includes triggering a beam group reconfiguration to merge or split beam groups when the allocation frequency exceeds a configurable Reconfiguration Trigger Limit, ensuring balanced RACH resource distribution across the network.

Dynamically adjusting the number of RACH occasions includes deallocating a RACH occasion from a beam group when the congestion score falls below the previous score by a predefined Congestion Decrease Offset, and further includes maintaining a minimum number of RACH occasions per beam group to ensure baseline emergency access availability, as determined by a configurable minimum resource constraint.

Deallocating a RACH occasion from a beam group further includes adding a configurable resource reallocation minimum delay to prevent rapid oscillation of RACH occasion assignments, while ensuring at least one RACH occasion remains available per beam group unless a predefined Low Activity Threshold is met.

Deallocating a RACH occasion from a beam group further includes redistributing deallocated RACH occasions to other active random-access beam groups with congestion scores approaching the Congestion Increase Threshold, by a predefined congestion score offset.

Tagging specific RACH occasions includes associating each occasion with a service type indication, such as “medical emergency,” “fire,” or “critical sensing update,” based on operator-defined policies, and further includes reserving a configurable percentage of RACH occasions per beam group exclusively for general or default service types triggering random-access.

The broadcast of the BRMT includes transmitting the table at a configurable time periodicity, as part of a device-common downlink control channel information (DCI) or system information blocks (SIBs).

Broadcasting a fallback RACH occasion pool in the BRMT, wherein the fallback pool includes a set of untagged RACH occasions accessible by all WTRUs regardless of service type or beam group, and wherein the fallback pool is activated only when the congestion score of a beam group exceeds a predefined Critical Congestion Threshold.

A Wireless Transmit/Receive Unit (WTRU) may comprise:
Circuitry configured to select one or more random-access eligible beam groups from which the best beam's received coverage level exceeds a configurable Minimum received coverage threshold Threshold;
Circuitry configured to choose and activate the random-access beam group with the lowest congestion score based on the received Beam Resource Mapping Table (BRMT);
Circuitry configured to select a RACH occasion, associated with the activated random-access beam group, from the general RACH occasion pool for random-access triggering general services or from a corresponding tagged RACH occasion pool for service-specific triggers; and
A transmitter configured to transmit an emergency preamble using an arbitrary beam-group-specific precoding vector of the selected random-access beam group.

Selecting a tagged RACH occasion for specific service triggers, such as “emergency,” “fire,” or “critical sensing update,” involves matching the WTRU's emergency service type to the service tag in the BRMT, and further includes prioritizing tagged occasions over general occasions only when the tagged occasion's associated beam group has a congestion score below a predefined Service Priority Congestion Limit, falling back to a general occasion otherwise.

Selecting a RACH occasion further includes falling back to a general RACH occasion from the general RACH occasion pool associated with the selected beam group if a configurable number of failed preamble transmissions is experienced over the tagged RACH occasion, wherein the fallback is triggered after a predefined Failure Count Threshold is reached to ensure reliable emergency access.

Transmitting an emergency preamble using an arbitrary beam-group-specific precoding vector involves adopting the precoding vector of the best serving beam within the selected random-access beam group, the best serving beam having the highest received coverage level, wherein the receiving Radio Access Network (RAN) node is configured to blind decode all potential receive beams associated with the identified beam group to decode the received random-access preamble.

Transmitting an emergency preamble using the best serving beam with the highest received coverage level within the selected random-access beam group, further includes the WTRU signaling and transmitting a beam identifier in the preamble transmission to assist the RAN node in prioritizing specific receive beams.

Transmitting an emergency preamble using an arbitrary beam-group-specific precoding vector comprises adopting a precoding vector that is the average of and/or a weighted filter of the precoding vectors of all beams belonging to the selected random-access beam group, calculated as a weighted mean based on their respective received coverage levels values, wherein the receiving RAN node employs a single receive beam decoding vector matched to the WTRU average precoding vector to decode the random-access preamble.

Transmitting an emergency preamble using the best serving beam with the highest received coverage level further includes the WTRU applying a configurable Power Boost Factor or service-specific transmission power offset to the preamble transmission for random-access occasions associated with high-priority service types, such as “medical emergency,” as indicated in the BRMT.

1. A method performed by a user equipment (UE), the method comprising:
receiving, via radio resource control (RRC) signaling, information used to configure a first random access channel (RACH) occasion (RO) of a first RO group for physical random access channel (PRACH) transmissions associated with a same or different beam and a time offset; and
transmitting one or more PRACH signals on one or more ROs in accordance with the information used to configure and the time offset.

2. The method of claim 1, wherein the PRACH transmissions are on the same beam.

3. The method of claim 1, wherein the PRACH transmissions are on different beams.

4. The method of claim 1, wherein the PRACH transmissions are on same beams and different beams.

5. The method of claim 1, wherein separate PRACH transmissions associated with a plurality of beams are made during a single RO.

6. The method of claim 1, wherein the plurality of beams are associated with a same synchronization signal block (SSB).

7. A method performed by a UE, the method comprising:
receiving a synchronization signal block (SSB) and decoding system information (SI);
in response to receiving the SI, transmitting a plurality of PRACH signals associated with different beams on one or more random access channel (RACH) occasions (ROs) separated in time;
receiving beam information; and
transmitting MSG3 in accordance with the beam information.

8. The method of claim 7, wherein the system supports no less than 4 PRACH transmissions each associated with a different beam.

9. The method of claim 7, wherein an RO group size is 2, wherein RO group is indicated by DCI.

10. A base station comprising:
a processor; and
a transceiver;
wherein the transceiver is configured to transmit a master information block (MIB) indicative of a system information block (SIB), wherein the SIB comprises AI and/or ML training information.

11. The base station of claim 10, wherein the transceiver is:
configured to send one or more AI models to individual wireless transmit receive units (WTRUs) via dedicated data channels; and
configured to send one or more AI models to a group of WTRUs via a group-common channel using shared PRBs.

12. The base station of claim 11, wherein the transceiver transmits downlink control information (DCI) comprising a model ID, a version ID and a group-common radio network temporary identifier (RNTI) corresponding to the one or more AI models of the group of WTRUs.
